(19) United States
(12) Patent Application Publication
(10) Pub. No.: US 2014/0126782 A1
(43) Pub. Date: May 8, 2014

(54) IMAGE DISPLAY APPARATUS, IMAGE DISPLAY METHOD, AND COMPUTER PROGRAM

(71) Applicant: Sony Corporation, Tokyo (JP)

(72) Inventors: Motoyuki Takai, Tokyo (JP); Yoichiro Sako, Tokyo (JP); Yasushi Miyajima, Kanagawa (JP); Hiroshi Mukawa, Kanagawa (JP); Tatsuya Narahara, Kanagawa (JP); Masashi Takeda, Tokyo (JP); Hiroaki Ogawa, Chiba (JP); Seiji Wada, Kanagawa (JP); Ichigo Hayakawa, Tokyo (JP); Akira Tange, Tokyo (JP); Takao Tanikame, Kanagawa (JP); Kazuhide Kemmochi, Tokyo (JP)

(73) Assignee: Sony Corporation, Tokyo (JP)

(21) Appl. No.: 14/061,265

(22) Filed: Oct. 23, 2013

(30) Foreign Application Priority Data
Nov. 2, 2012 (JP) 2012-243184

(51) Int. Cl. G06K 9/00

(52) U.S. Cl. CPC G06K 9/00281; G06K 9/0061
USPC 382/116

(57) ABSTRACT

An image display apparatus used while it is mounted on a user's head or facial area includes a display unit configured to display an inside image viewable from the user; an input unit configured to input an identification pattern from the user; a checking unit configured to check the identification pattern; and a control unit configured to control the image display apparatus on the basis of a result of the checking by the checking unit.

### CROSS REFERENCE TO RELATED APPLICATIONS

This application claims the benefit of Japanese Priority Patent Application JP 2012-243184 filed Nov. 2, 2012, the entire contents of which are incorporated herein by reference.

### BACKGROUND

The present technology relates to an image display apparatus that a user wears on his or her head or facial area and uses to view images, an image display method, and a computer program. In particular, the present technology relates to an image display apparatus, an image display method, and a computer program which perform, for example, authentication of a user wearing the image display apparatus on his or her head or facial area.

Head-mounted image display apparatuses, which are mounted on the head and are used to view images, have been available (the apparatuses are generally referred to as “head-mounted displays”). A head-mounted image display apparatus has, for example, respective image display units for the left and right eyes and is also configured to be capable of controlling visual and auditory senses when used together with headphones. The head-mounted image display apparatus can show different images to the left and right eyes, and can also present a three-dimensional image by displaying images having parallax therebetween to the left and right eyes.

Head-mounted image display apparatuses can also be classified into an opaque type and a see-through type. The opaque-type head-mounted image display apparatus is designed so as to directly cover a user's eyes when mounted on his or her head, and offers the user a greater sense of immersion during image viewing. On the other hand, in the case of the see-through type head-mounted image display apparatus, even when it is mounted on a user's head to display an image, he or she can view a real-world scene through the displayed image (i.e., can see through the display). Accordingly, the see-through type head-mounted image display apparatus can show a virtual display image on the real-world scene in a superimposed manner.

In coming years, head-mounted image display apparatuses are expected to employ the capabilities of multifunction terminals, such as smartphones, and to incorporate a variety of applications relating to augmented reality and so on. Once the head-mounted image display apparatuses offer greater added value, other than content viewing, and are intended for users to use at all times in their life, various types of information, such as sensitive information, will be stored therein. Accordingly, security control involving, for example, checking user authenticity when the user starts using the head-mounted image display apparatuses, will become more important.

In the field of information processing, authentication methods based on user password input have been widely used. However, with an image display apparatus used while mounted on a user's head or facial area, it is difficult to equip the main unit of the image display apparatus with a device (e.g., a keyboard) for inputting a password. There is also a problem in that the user wearing the image display apparatus has to perform a key input operation in a substantially blindfolded state.

For example, Japanese Unexamined Patent Application Publication No. 2003-167855 discloses an information terminal system in which, when the main unit of an information terminal device starts to operate, a detecting device provided in a head-mounted display reads biological feature information of a retina or iris in an eyeball or the like of an individual user to authenticate the user. Once the user authentication is established, the user is permitted to operate the information terminal device correspondingly to the authority of the user and desired information is displayed on the head-mounted display, without user authentication before each use unless he or she removes the head-mounted display.

For example, Japanese Unexamined Patent Application Publication No. 2007-322769 discloses a video display system that obtains biometric information, which is information of an iris, retina, or face of a user wearing a video display apparatus, and that verifies whether or not the user is the person he or she claims to be on the basis of the biometric information.

Technology for performing personal authentication on the basis of biological feature information of retinas, irises, or the like has been established and has been extensively used in various industrial fields. High-cost dedicated devices are generally used in order to read biological feature information of retinas, irises, or the like from users. Thus, installing such a device for authentication in information equipment intended for users to use at all times in their life has significant disadvantages in terms of cost. Devices for reading retinas, irises, or the like find almost no uses other than authentication and, once authentication is established, they are rarely utilized to execute daily applications.

### SUMMARY

An object of the technology disclosed herein is to provide an improved image display apparatus that a user wears on his or her head or facial area and uses to view images, an improved image display method, and an improved computer program.

Another object of the technology disclosed herein is to provide an improved image display apparatus, an improved image display method, and an improved computer program which can preferably authenticate a user wearing the image display apparatus on his or her head or facial area.

The technology disclosed herein has been conceived in view of the foregoing situation, and there is provided an image display apparatus used while it is mounted on a user's head or facial area. The image display apparatus includes a display unit configured to display an inside image viewable from the user; an input unit configured to input an identification pattern from the user; a checking unit configured to check the identification pattern; and a control unit configured to control the image display apparatus on the basis of a result of the checking by the checking unit.

The checking unit may check authenticity of the user, and on the basis of whether or not the user is authentic, the control unit may determine whether or not predetermined processing is to be executed on the image display apparatus.

The image display apparatus may further include an authentication-pattern registering unit configured to pre-register an authentication pattern that an authentic user inputs via the input unit. The checking unit may check the authenticity of the user on the basis of a degree of matching between an identification pattern that the user inputs via the input unit and an authentication pattern pre-registered in the authentication-pattern registering unit.

The image display apparatus may further include a line-of-sight detecting unit configured to detect the user's line of sight. The input unit may input an identification pattern based on the user's gaze-position or gaze-point movement obtained from the line-of-sight detecting unit.

The line-of-sight detecting unit may include at least one of an inside camera capable of photographing an eye of the user, a myoelectric sensor, and an electrooculogram sensor.

The image display apparatus may further include a motion detecting unit configured to detect movement of the head or body of the user wearing the image display apparatus. The input unit may input an identification pattern based on the user's head or body movement obtained from the motion detecting unit.

The motion detecting unit in the image display apparatus may include at least one of an acceleration sensor, a gyro-sensor, and a camera.

The image display apparatus may further include a voice detecting unit configured to detect voice uttered by the user. The input unit may input an identification pattern based on the voice obtained from the voice detecting unit.

The image display apparatus may further include a bone-conduction signal detecting unit configured to detect a speech bone-conduction signal resulting from utterance of the user. The input unit may input an identification pattern based on the speech bone-conduction signal obtained from the bone-conduction signal detecting unit.

The image display apparatus may further include a feature detecting unit configured to detect a shape feature of the user's face or facial part. The input unit may input an identification pattern based on the shape feature of the user's face or facial part.

The feature detecting unit in the image display apparatus may detect at least one of shape features of an eye shape, an inter-eye distance, a nose shape, a mouth shape, a mouth opening/closing operation, an eyelash, an eyebrow, and an earlobe of the user.

The image display apparatus may further include an eye-blinking detecting unit configured to detect an eye-blinking action of the user. The input unit may input an identification pattern based on the user's eye blinking obtained from the eye-blinking detecting unit.

The eye-blinking detecting unit in the image display apparatus may include at least one of an inside camera capable of photographing the user's eye, a myoelectric sensor, and an electrooculogram sensor.

The image display apparatus may further include a feature detecting unit configured to detect a shape feature of the user's hand, finger, or fingerprint. The input unit may input an identification pattern based on the shape feature of the user's hand, finger, or fingerprint.

The image display apparatus may further include an intra-body communication unit configured to perform intra-body communication with an authenticated device worn by the user or carried by the user with him or her and to read information from the authenticated device. The input unit may input an identification pattern based on the information read from the authenticated device by the intra-body communication unit.

The image display apparatus may further include a guidance-information display unit configured to display, on the display unit, guidance information that provides guidance for an operation by which the user inputs an identification pattern via the input unit.

The image display apparatus may further include a guidance-information display unit configured to display, on the display unit, guidance information that provides guidance for an operation by which an authentication pattern is input, when the user pre-registers an authentication pattern in the authentication-pattern registering unit.

The image display apparatus may further include an input-result display unit configured to display, on the display unit, a result of the user inputting an identification pattern via the input unit.

According to the technology disclosed herein, there is provided an image display method for an image display apparatus used while it is mounted on a user's head or facial area. The image display method includes inputting an identification pattern from the user; checking the identification pattern; and controlling the image display apparatus on the basis of a result of the checking.

According to the technology disclosed herein, there is provided a computer program written in a computer-readable format so as to control, on a computer, operation of an image display apparatus used while mounted on a user's head or facial area. The computer program causing the computer to function as a display unit that displays an inside image viewable from the user; an input unit that inputs an identification pattern from the user; a checking unit that checks the identification pattern; and a control unit that controls the image display apparatus on the basis of a result of the checking by the checking unit.

The computer program disclosed herein is written in a computer-readable format so as to realize predetermined processing on a computer. In other words, the computer program disclosed herein is installed to a computer to provide a cooperative effect on the computer, thereby making it possible to offer advantages that are similar to those of the image display apparatus disclosed herein.

The technology disclosed herein can provide an improved image display apparatus, an improved image display method, and an improved computer program which can realize, in a more-simplified manner and at low cost, authentication processing of a user wearing the image display apparatus on his or her head or facial area.

According to the technology disclosed herein, user identification and authentication processing can be performed in a simplified manner and at low cost, on the basis of a user's identification pattern that can be input from a device generally included in the image display apparatus.

Further objects, features, and advantages of the technology disclosed herein will become apparent from more detailed descriptions based on the following embodiments and the accompanying drawings.

### BRIEF DESCRIPTION OF THE DRAWINGS

FIG. 1 is a front view illustrating the state of a user wearing a see-through type head-mounted image display apparatus;

FIG. 2 is a top view illustrating the state of the user wearing the image display apparatus illustrated in FIG. 1;

FIG. 3 is a front view illustrating the state of a user wearing an opaque-type head-mounted image display apparatus;

FIG. 4 is a top view illustrating the state of the user wearing the image display apparatus illustrated in FIG. 3;

FIG. 5 illustrates an example of the internal configuration of the image display apparatus;

FIG. 6 schematically illustrates a functional configuration with which the image display apparatus performs user identification and authentication processing on the basis of information on user operation;

FIG. 7 schematically illustrates a functional configuration (a modification of FIG. 6) with which the image display apparatus performs user identification and authentication processing on the basis of information on user operation;

FIG. 8 illustrates an example of combinations of identification patterns dealt with by a user identifying and authenticating unit and environmental sensors and state sensors used for inputting the identification patterns;

FIG. 9A illustrates an example of guidance information displayed when a user inputs an identification pattern involving movement of his or her gaze point;

FIG. 9B illustrates a state in which the user inputs, via the guidance-information display screen illustrated in FIG. 9A, a personal identification number by using his or her line of sight;

FIG. 10A is a modification of the guidance-information display illustrated in FIG. 9A;

FIG. 10B illustrates a state in which the user inputs a personal identification number via the guidance-information display screen illustrated in FIG. 10A by using his or her line of sight;

FIG. 10C is a modification of the guidance-information display illustrated in FIG. 10A;

FIG. 11A illustrates an example of guidance information in which multiple image objects that serve as targets at which a line of sight is set are scattered;

FIG. 11B illustrates a state in which the user draws a desired gaze-point trace by moving his or her line of sight via the guidance-information display screen illustrated in FIG. 11A;

FIG. 12 is a display example of guidance information in which a large number of face images are randomly arranged;

FIG. 13A illustrates an example of guidance information displayed when the user inputs an identification pattern for his or her head;

FIG. 13B illustrates an example of a screen when information of detected head movement is displayed on the guidance information illustrated in FIG. 13A in a superimposed manner;

FIG. 13C illustrates an example of a screen when information of detected head movement is displayed on the guidance information illustrated in FIG. 13A in a superimposed manner;

FIG. 13D illustrates an example of a screen when information of detected head movement is displayed on the guidance information illustrated in FIG. 13A in a superimposed manner;

FIG. 14A illustrates an example of guidance information displayed when voice uttered by the user or a speech bone-conduction signal is used as an identification pattern for the user identification and authentication;

FIG. 14B illustrates an example of a screen on which detected voice information is displayed in the guidance information illustrated in FIG. 14A;

FIG. 15A illustrates an example of guidance information when an eye-blinking action performed by the user is input as an identification pattern for the user identification and authentication;

FIG. 15B illustrates an example of a screen when icons representing detected eye-blinking actions are displayed in the guidance information illustrated in FIG. 15A;

FIG. 16 illustrates a state in which the user performs eye-blinking actions while drawing a desired gaze-point trace by moving his or her line of sight via the guidance-information display screen illustrated in FIG. 11A;

FIG. 17 illustrates an example of guidance information for prompting the user to possess an authentication device (a wristwatch);

FIG. 18 illustrates an example of guidance information for prompting the user to possess an authentication device (a ring);

FIG. 19 illustrates an example of guidance information for prompting the user to possess an authentication device (a card);

FIG. 20 is a flowchart illustrating a processing procedure for pre-registering, in the image display apparatus, an authentication pattern used for the user identification and authentication processing; and

FIG. 21 is a flowchart illustrating a processing procedure for the image display apparatus to perform the user identification and authentication processing.

### DETAILED DESCRIPTION OF EMBODIMENT

An embodiment according to the technology disclosed herein will be described below in detail with reference to the accompanying drawings.

### A. Apparatus Configuration

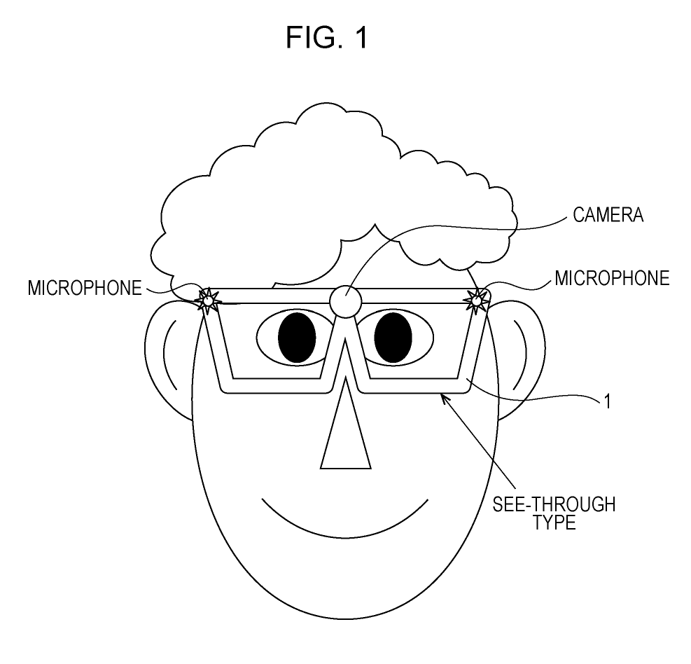

FIG. 1 is a front view illustrating the state of a user wearing a see-through type head-mounted image display apparatus 1. The illustrated image display apparatus 1 has a structure that is similar to that of eyeglasses for vision correction. A main unit of the image display apparatus 1 has, at positions that oppose the user's left and right eyes, virtual-image optical units, which include transparent light-guiding units and so on. Images observed by the user are displayed inside the virtual-image optical units. The virtual-image optical units are supported by, for example, a support having an eyeglass-frame shape.

The support having the eyeglass-frame shape has, at approximately the center thereof, a camera for inputting an image of the surroundings (in the user's field of view). Microphones are also disposed near corresponding left and right opposite ends of the support. Since two microphones are provided, only a voice (the user's voice) localized at the center can be recognized and can thus be separated from ambient noise and the speech of other people. Hence, for example, malfunctions during operation based on voice input can be minimized.

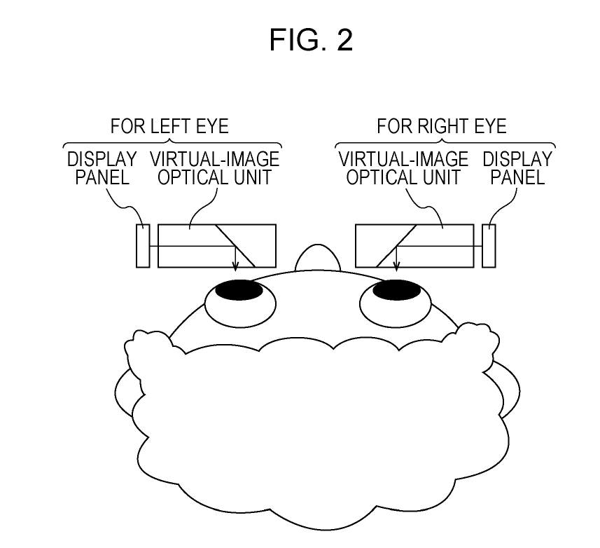

FIG. 2 is a top view of the image display apparatus 1 when it is worn by the user. As illustrated, the image display apparatus 1 has, at the left and right opposite ends thereof, display panels for displaying images for the left and right eyes. The display panels are implemented by micro-displays, such as liquid crystal displays or organic EL elements. The left and right display images output from the display panels are guided to the vicinities of the left and right eyes by the virtual-image optical units, and enlarged virtual images are formed at the user's pupils.

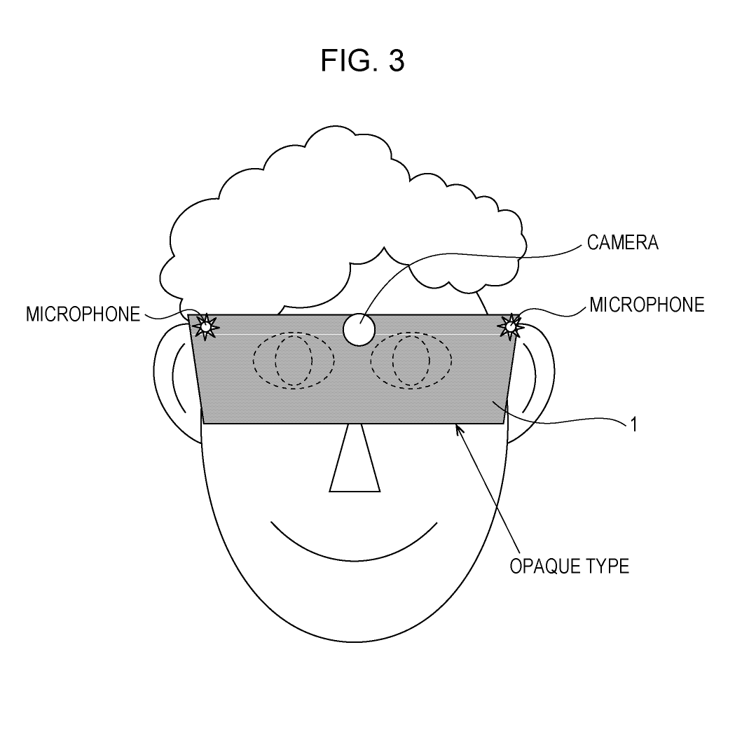

FIG. 3 is a front view illustrating the state of a user wearing an opaque-type head-mounted image display apparatus 1. The image display apparatus 1 illustrated in FIG. 3 has a structure having a shape that is similar to that of a visor and is configured to directly cover the left and right eyes of the user wearing the image display apparatus 1. The image display apparatus 1 illustrated in FIG. 3 has display panels (not illustrated in FIG. 3), which are observed by the user, at positions that are located inside of a main unit of the image display apparatus 1 and that oppose the respective left and right eyes of the user. The display panels are implemented by, for example, micro-displays, such as organic EL elements or liquid crystal displays.

The main unit of the image display apparatus 1 having a shape similar to a visor has, at approximately the center of a front face thereof, a camera for inputting an image of the surroundings (in the user's field of view). The main unit of the image display apparatus 1 also has microphones at the vicinities of the left and right opposite ends thereof. Since two microphones are provided, only a voice (the user's voice) localized at the center can be recognized and can thus be separated from ambient noise and the speech of other people. Hence, for example, malfunctions during operation based on voice input can be minimized.

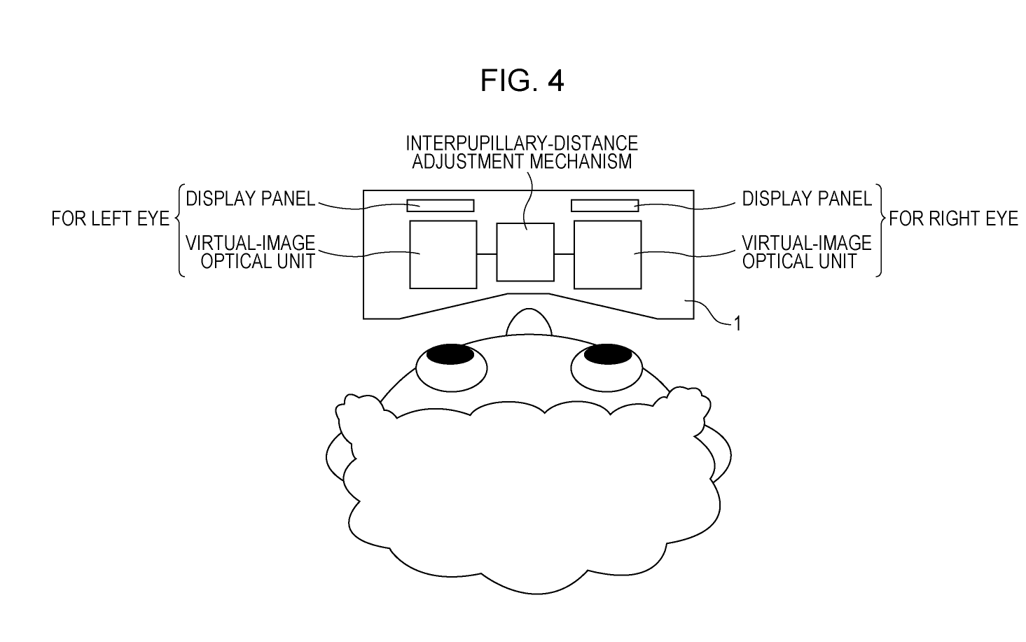

FIG. 4 is a top view illustrating the state of the user wearing the image display apparatus 1 illustrated in FIG. 3. The illustrated image display apparatus 1 has display panels for the left and right eyes at positions that oppose the user's face. The display panels are implemented by, for example, micro-displays, such as organic EL elements or liquid crystal displays. Images displayed on the display panels pass through the corresponding virtual-image optical units, so that the resulting images are observed as enlarged virtual images by the user. Since the height of the eyes and the interpupillary distance differ from one user to another, it is important to align the left and right display systems with the user's eyes. In the example illustrated in FIG. 4, an interpupillary-distance adjustment mechanism is provided between the display panel for the left eye and the display panel for the right eye.

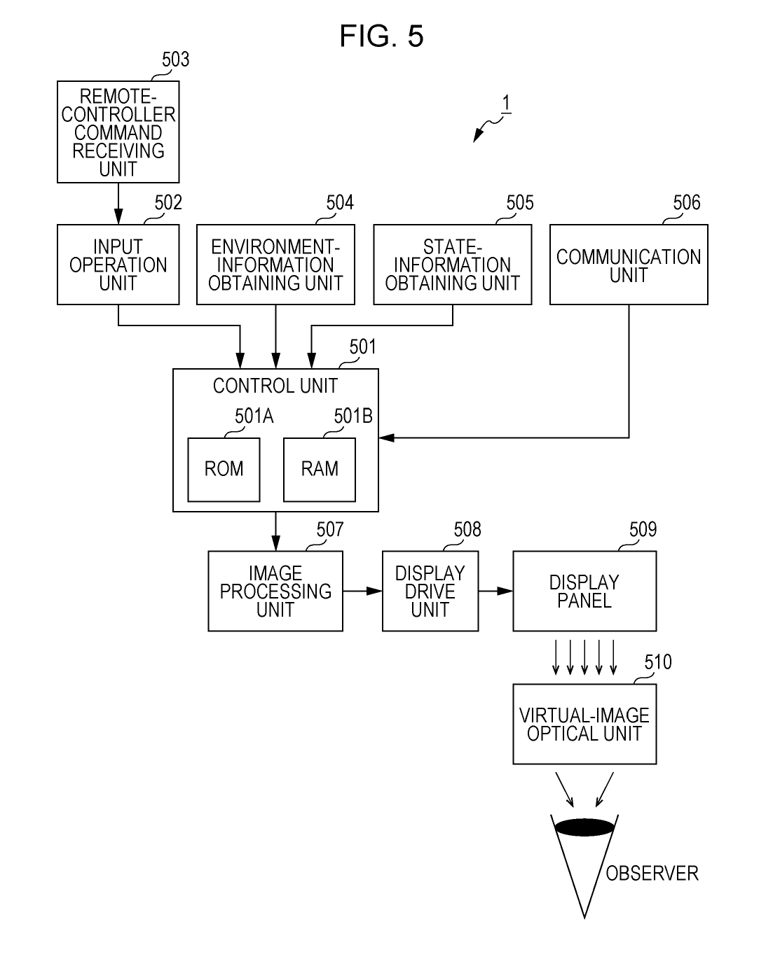

FIG. 5 illustrates an example of the internal configuration of the image display apparatus 1. Individual units included in the image display apparatus 1 will be described below.

A control unit 501 includes a read only memory (ROM) 501A and a random access memory (RAM) 501B. The ROM 501A stores therein program code executed by the control unit 501 and various types of data. The control unit 501 executes a program, loaded into the RAM 501B, to thereby initiate playback control on content to be displayed on display panels 509 and to centrally control the overall operation of the image display apparatus 1. Examples of the program executed by the control unit 501 include various application programs for displaying images for content viewing, as well as a user identifying and authenticating program executed when the user starts using the image display apparatus 1. Details of a processing operation performed by the user identifying and authenticating program are described below later. The ROM 501A is an electrically erasable programmable read-only memory (EEPROM) device, to which important data, such as an identification pattern used for user identification and authentication processing, can be written.

An input operation unit 502 includes one or more operation elements, such as keys, buttons, and switches, with which the user performs input operation. Upon receiving a user instruction via the operation elements, the input operation unit 502 outputs the instruction to the control unit 501. Similarly, upon receiving a user instruction including a remote-controller command received by a remote-controller command receiving unit 503, the input operation unit 502 outputs the instruction to the control unit 501.

An environment-information obtaining unit 504 obtains environment information regarding an ambient environment of the image display apparatus 1 and outputs the environment information to the control unit 501. Examples of the environment information obtained by the environment-information obtaining unit 504 include an ambient light intensity, a sound intensity, a location or place, a temperature, weather, time, and an image of the surroundings. In order to obtain those pieces of environment information, the environment-information obtaining unit 504 may have various environmental sensors, such as a light-intensity sensor, a microphone, a global positioning system (GPS) sensor, a temperature sensor, a humidity sensor, a clock, an outside camera pointing outward to photograph an outside scene (an image in the user's field of view), and a radiation sensor (none of which are illustrated in FIG. 5). Alternatively, the arrangement may be such that the image display apparatus 1 itself has no environmental sensors and the environment-information obtaining unit 504 obtains environment information from an external apparatus (not illustrated) equipped with environmental sensors. The obtained environment information may be used for user identification and authentication processing executed when the user starts using the image display apparatus 1. The environment information may be temporarily stored in, for example, the RAM 501B.

A state-information obtaining unit 505 obtains state information regarding the state of the user who uses the image display apparatus 1, and outputs the state information to the control unit 501. Examples of the state information obtained by the state-information obtaining unit 505 include the states of tasks of the user (e.g., as to whether or not the user is wearing the image display apparatus 1), the states of operations and actions performed by the user (e.g., the attitude of the user's head on which the image display apparatus 1 is mounted, the movement of the user's line of sight, movement such as walking, and open/close states of the eyelids), and mental states (e.g., the level of excitement, the level of awareness, and emotion and affect, such as whether the user is immersed in or focused on viewing inside images displayed on the display panels 509), as well as the physiological states of the user. In order to obtain those pieces of state information from the user, the state-information obtaining unit 505 may have various state sensors, such as a GPS sensor, a gyro-sensor, an acceleration sensor, a speed sensor, a pressure sensor, a body-temperature sensor, a perspiration sensor, a myoelectric sensor, an electrooculogram sensor, a brain-wave sensor, an inside camera pointing inward, i.e., toward the user's face, and a microphone for inputting voice uttered by the user, as well as an attachment sensor having a mechanical switch (none of which are illustrated in FIG. 5). For example, on the basis of information output from the myoelectric sensor, the electrooculogram sensor, or the inside camera, the state-information obtaining unit 505 can obtain the line of sight (eyeball movement) of the user wearing the image display apparatus 1 on his or her head. The obtained state information may be used for user identification and authentication processing executed when the user starts using the image display apparatus 1. The state information may be temporarily stored in, for example, the RAM 501B.

A communication unit 506 performs communication processing with another apparatus and modulation/demodulation and encoding/decoding processing on communication signals. For example, the communication unit 506 receives, from external equipment (not illustrated) serving as an image source, image signals for image display and image output through the display panels 509. The communication unit 506 performs demodulation and decoding processing on the received image signals to obtain image data. The communication unit 506 supplies the image data or other received data to the control unit 501. The control unit 501 can also transmit data to external equipment via the communication unit 506.

The communication unit 506 may have any configuration. For example, the communication unit 506 can be configured in accordance with a communication standard used for an operation for transmitting/receiving data to/from external equipment with which communication is to be performed. The communication standard may be a standard for any of wired and wireless communications. Examples of the “communication standard” as used herein include standards for Mobile High-definition Link (MHL), Universal Serial Bus (USB), High Definition Multimedia Interface (HDMI), Bluetooth (registered trademark) communication, infrared communication, Wi-Fi (registered trademark), Ethernet (registered trademark), contactless communication typified by near field communication (NFC), and intra-body communication. The image display apparatus 1 can also utilize a cloud computer (not illustrated) by connecting to a wide area network, such as the Internet, via the communication unit 506. For example, when part or all of the user identification and authentication processing is to be executed on the cloud computer, the control unit 501 transmits information used for the processing to the cloud computer via the communication unit 506.

An image processing unit 507 further performs signal processing, such as image-quality correction, on image signals to be output from the control unit 501 and also converts the resolution of the image signals into a resolution suitable for screens of the display panels 509. A display drive unit 508 sequentially selects pixels in each display panel 509 row by row, performs line sequential scanning, performs signal processing on image signals, and supplies the resulting image signals.

The display panels 509 are implemented by, for example, micro-displays, such as organic EL elements or liquid crystal displays, and display inside images, which can be seen from the user wearing the image display apparatus 1 in the manner illustrated in FIG. 2 or 4. The virtual-image optical units 510 enlarge and project the images displayed on the corresponding display panels 509, so that the images are observed as enlarged virtual images by the user.

In the case of the see-through type image display apparatus 1, the virtual-image optical units 510 includes, for example, diffractive-optical elements (see, for example, Japanese Unexamined Patent Application Publication No. 2012-88715). In the case of the opaque-type image display apparatus 1, the virtual-image optical units 510 include, for example, ocular optical lenses (see, for example, Japanese Unexamined Patent Application Publication No. 2012-141461).

When the image display apparatus 1 is a binocular type, the display panels 509 and the virtual-image optical units 510 are provided for the left and right eyes, respectively, and when the image display apparatus 1 is a monocular type, the display panel 509 and the virtual-image optical unit 510 are provided for only one eye.

### B. User Identification and Authentication Processing

Although not illustrated in FIG. 5, the image display apparatus 1 may have the capabilities of a multifunction terminal, such as a smartphone, and is intended for a user to use at all times in his or her life, with greater added value other than content viewing. In such a case, it is presumed that various types of information, such as sensitive information, are stored in the image display apparatus 1, and thus, security control involving, for example, checking the authenticity of a user, will become more important.

In the case of the image display apparatus 1 that the user uses while it is mounted on his or her head or facial area, when he or she attempts to perform password-based authentication processing, he or she has to perform an input operation in a substantially blindfolded state (or with one eye, when the image display apparatus 1 is a monocular type). The image display apparatus 1 mounted on a user's head or facial area also has the feature that it is easy to directly obtain information from the user. Although authentication processing utilizing biometric information, such as a retina or iris, is also conceivable, such authentication processing involves a read-only device, which leads to an increase in the apparatus cost.

Accordingly, in the present embodiment, the image display apparatus 1 is configured so as to perform user identification and authentication processing in a more-simplified manner and at low cost on the basis of and by making use of a user's identification pattern arbitrarily input from a device generally included in the image display apparatus 1, without relying on any complicated system for fingerprint authentication, iris authentication, or the like.

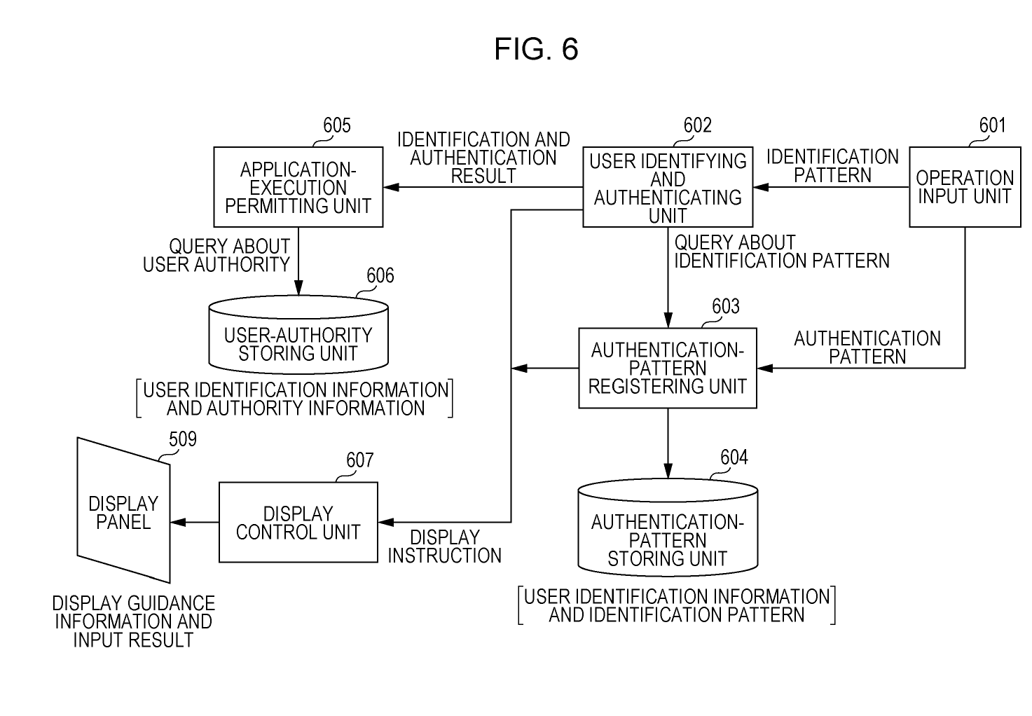

FIG. 6 schematically illustrates a functional configuration with which the image display apparatus 1 performs user identification and authentication processing on the basis of information on user operation.

When the use of the image display apparatus 1 is started, an identification pattern provided by the user wearing the image display apparatus 1 is input to an operation input unit 601.

On the basis of the user's identification pattern input from the operation input unit 601, a user identifying and authenticating unit 602 performs user identification and authentication processing, i.e., checks the authenticity of the user.

For example, an identification pattern based on which the user identification and authentication processing is to be performed may be pre-registered for each user, in which case the user identifying and authenticating unit 602 may perform matching between the pre-registered identification pattern and an identification pattern input via the operation input unit 601 at the start of use to thereby perform the user identification and authentication processing.

When the pre-registered identification pattern is used to perform the user identification and authentication processing, an authentication-pattern registering unit 603 pre-stores an authentication pattern, input from the operation input unit 601 for pre-registration, in an authentication-pattern storing unit 604 in association with user identification information for each user. The user identifying and authenticating unit 602 queries the authentication-pattern registering unit 603 about the identification pattern input from the operation input unit 601 when the use of the image display apparatus 1 is started, to obtain information indicating whether or not a user attempting to start using the image display apparatus 1 is a pre-registered legitimate user and to which of the registered legitimate users that user corresponds (i.e., user identification information).

Needless to say, a case in which the same authentication pattern is used among all users who use the image display apparatus 1 is also conceivable. In such a case, the arrangement may be such that the authentication-pattern storing unit 604 stores therein an authentication pattern to be used by the image display apparatus 1 and, during the user identification and authentication processing, the user identifying and authenticating unit 602 reads the authentication pattern from the authentication-pattern storing unit 604 via the authentication-pattern registering unit 603.

When the user inputs an identification pattern to the operation input unit 601, the user identifying and authenticating unit 602 may instruct a display control unit 607 so as to display, on the display panel 509, a screen showing guidance information that provides guidance for the user to input the identification pattern and a result of the input of the identification pattern. Similarly, when the user pre-registers his or her identification pattern for the user identification and authentication, the authentication-pattern registering unit 603 may instruct the display control unit 607 so as to display, on the display panel 509, a screen showing information that provides guidance for the user to input the identification pattern and a result of the input of the identification pattern. With such an arrangement, the user can input an identification pattern without error in accordance with the guidance-information displayed on the display panel 509. By seeing the thus-far input result on the screen on the display panel 509, the user can also check whether or not the identification pattern has been input as he or she intended to. Since the display panels 509 are directed to the inside of the image display apparatus 1, that is, are directed to lateral sides of positions that face the user's face, what is displayed on the display panels 509 are not viewable from outside. Thus, even when the guidance information and the identification pattern are displayed, there is no risk of leakage thereof. Details of a method for displaying the guidance information are described later.

When the user identification and authentication processing has succeeded, the user identifying and authenticating unit 602 reports, to an application-execution permitting unit 605, a result indicating that the user identification and authentication processing has succeeded. For identifying an individual user who starts using the image display apparatus 1, the user identifying and authenticating unit 602 may output that result including the user identification information to the application-execution permitting unit 605.

Upon receiving, from the user identifying and authenticating unit 602, the result indicating that the user identification and authentication processing has succeeded, the application-execution permitting unit 605 permits execution of an application with respect to an application execute instruction subsequently given by the user.

When the image display apparatus 1 has set an execution authority for an application for each user, a user-authority storing unit 606 pre-stores therein authority information for each user in association with the corresponding user identification information. On the basis of the user identification information passed from the user identifying and authenticating unit 602, the application-execution permitting unit 605 queries the user-authority storing unit 606 to obtain the authority information given to the user. With respect to the application execute instruction subsequently given by the user, the application-execution permitting unit 605 permits execution of an application within a range defined by the obtained authority information.

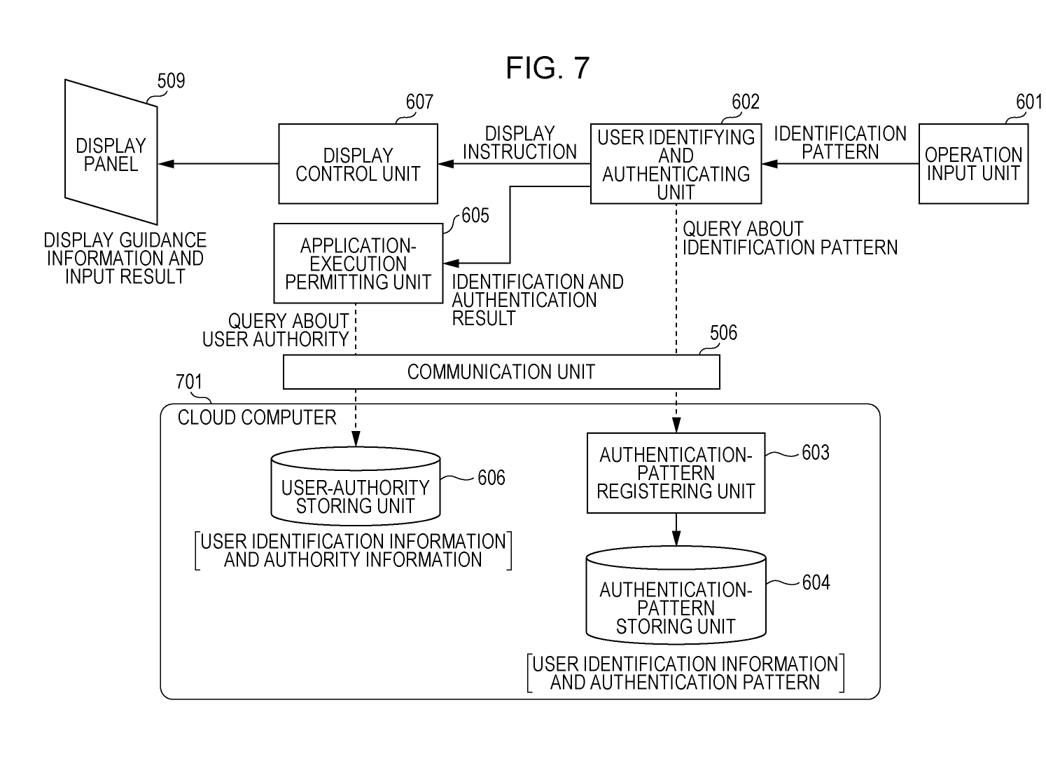

A configuration in which some functions are provided outside the image display apparatus 1 is also conceivable as a modification of the functional configuration illustrated in FIG. 6. For example, as illustrated in FIG. 7, the functions of the authentication-pattern registering unit 603, the authentication-pattern storing unit 604, and the user-authority storing unit 606 may be provided in a cloud computer 701 on a network. In this case, the user pre-registers, with the authentication-pattern registering unit 603 and in the authentication-pattern storing unit 604 in the cloud computer 701, his or her authentication pattern for the user identification and authentication. When the user starts using the image display apparatus 1, the user identifying and authenticating unit 602 can query, via the communication unit 506, the cloud computer 701 about the identification pattern input from the operation input unit 601, to perform user authentication and obtain the corresponding user identification information. When the user authentication succeeds and an instruction for executing an application is given from the user, the application-execution permitting unit 605 queries, via the communication unit 506, the cloud computer 701 about the user identification information passed from the user identifying and authenticating unit 602, to obtain the authority information given to the user. With respect to the application execute instruction subsequently given by the user, the application-execution permitting unit 605 permits execution of an application within a range defined by the obtained authority information.

According to the configuration example illustrated in FIG. 7, a case in which the identification pattern for the user authentication, the identification pattern being registered in one image display apparatus 1, and the application authority information set for each user are shared with another image display apparatus (not illustrated) is also conceivable.

The operation input unit 601 is implemented by an environmental sensor included in the image display apparatus 1 as the environment-information obtaining unit 504 and a state sensor included as the state-information obtaining unit 505. The user identifying and authenticating unit 602 can perform the user identification and authentication processing by using the identification pattern that can be directly input, using the environmental sensors and the state sensors, from the user wearing the image display apparatus 1. The image display apparatus 1 has multiple types of environmental sensor and state sensor and can deal with various identification patterns.

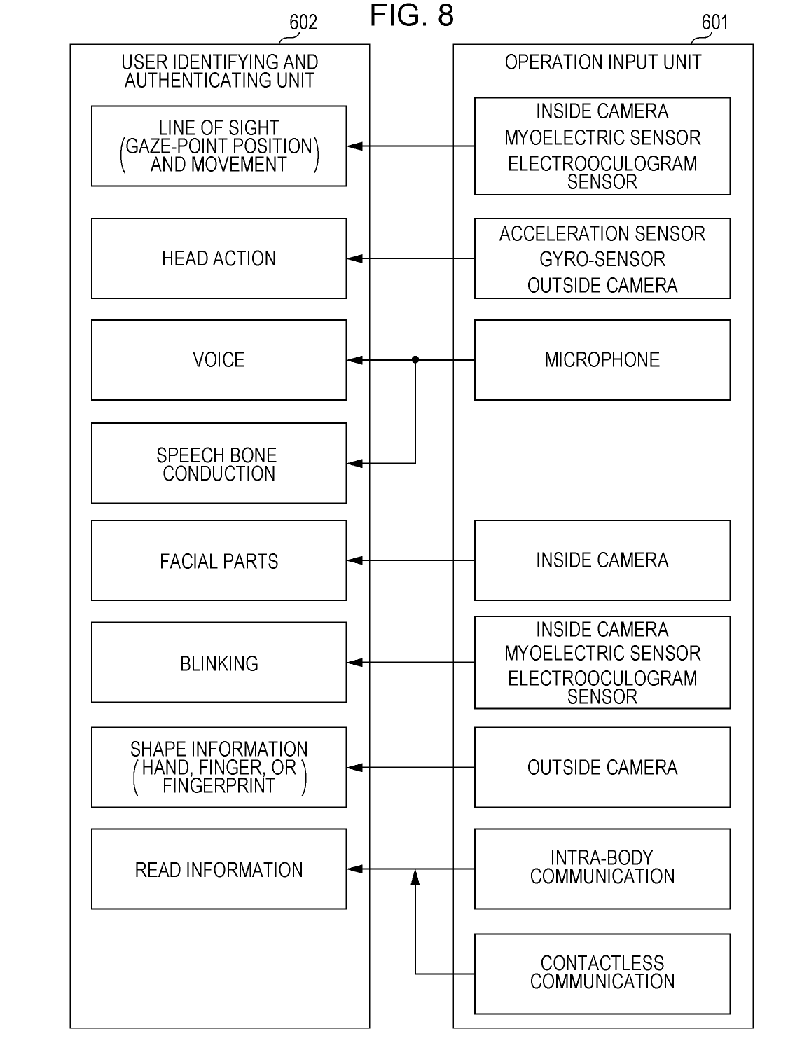

FIG. 8 illustrates an example of combinations of identification patterns dealt with by the user identifying and authenticating unit 602 and environmental sensors and state sensors used for inputting the identification patterns.

The operation input unit 601 can detect movement of the gaze position or gaze point of the user wearing the image display apparatus 1, by using any of the inside camera pointing toward the user's face and the myoelectric sensor and the electrooculogram sensor that respectively detect a muscle potential and an eye potential when in contact with the user's head or facial area. By using an identification pattern involving the movement of the gaze position or gaze point of the user, the user identifying and authenticating unit 602 can perform the user identification and authentication processing on the basis of a degree of matching with a pre-stored authentication pattern involving the movement of a gaze position or a gaze point.

When the image display apparatus 1 is an opaque type, since the user is in a blindfolded state or, stated conversely, since the user's eyes are hidden from the outside, there is no gap through which another person can peek during input of the identification pattern involving the movement of the gaze position or gaze point. Even when the image display apparatus 1 is a see-through type, making the display unit opaque during input of the identification pattern allows an identification pattern involving the movement of the gaze position or gaze point to be input without leaking to the outside. Even when more sensitive information is displayed on the display panel 509 as guidance information during movement of the gaze position or gaze point of the user, there is no risk of leakage of the guidance information.

By using an acceleration sensor, a gyro-sensor, or an outside camera pointing toward the opposite side from the user's face (i.e., pointing outside), the operation input unit 601 can also detect an action of the user's head and body, such as nodding, shaking the head to the left or right, moving forward or backward, jumping, or the like. By using an identification pattern involving the movement of the gaze position or gaze point of the user, the user identifying and authenticating unit 602 can perform the user identification and authentication processing on the basis of the degree of matching with a pre-stored authentication pattern for the head and body.

The operation input unit 601 can also detect the user's voice by using the microphone. By using an identification pattern involving the user's voice, the user identifying and authenticating unit 602 can perform the user identification and authentication processing on the basis of the degree of matching with a pre-stored authentication pattern for voice. In the present embodiment, since two microphones, that is, one for the vicinity of the left end of the main unit of the image display apparatus 1 and the other for the vicinity of the right end thereof, are provided, only a voice (the user's voice) localized at the center can be recognized by being separated from ambient noise and the speech of other people, as described above.

By using the microphone, the operation input unit 601 can also detect, in the form of a bone-conduction signal, voice information resulting from the user's speech. By using an identification pattern involving the speech bone-conduction signal, the user identifying and authenticating unit 602 can perform the user identification and authentication processing on the basis of the degree of matching with a pre-stored authentication pattern for the bone-conduction signal.

By using the inside camera pointing toward the user's face, the operation input unit 601 can capture the user's facial parts, such as the eyes, nose, mouth, eyebrows, and earlobes. By using a facial-part identifying pattern (including a pattern of a facial pattern itself) extracted by performing image processing on a captured user-facial-part image of an eye shape, an inter-eye distance, a nose shape, a mouth shape, a mouth opening/closing operation, an eyelash, an eyebrow, an earlobe, or the like, the user identifying and authenticating unit 602 preforms the user identification and authentication processing on the basis of the degree of matching with a pre-registered authentication pattern.

The operation input unit 601 can also detect an eye-blinking action of the user by using the inside camera pointing toward the user's face and the myoelectric sensor and the electrooculogram sensor that respectively detect a muscle potential and an eye potential when in contact with the user's head or facial area on which the image display apparatus 1 is mounted. By using the user's eye-blinking action pattern (such as the number of blinks, the frequency of blinking, a blinking interval pattern, and a combination of left and right blinks), the user identifying and authenticating unit 602 can perform the user identification and authentication processing on the basis of the degree of matching with a pre-stored authentication pattern.

By using the outside camera pointing toward the opposite side from the user's face (i.e., pointing outside) or the like, the operation input unit 601 can capture the user's hand, finger, and fingerprint. By using an identification pattern involving shape features of the user's hand or finger, movement of the hand or finger (such as a sign or gesture), or shape features of a fingerprint, the user identifying and authenticating unit 602 can perform the user identification and authentication processing on the basis of the degree of matching with a pre-stored authentication pattern for the head and body.

When the user has an authenticated device in the form of a wristwatch, an accessory such as a ring, a card, or the like, the operation input unit 601 can access the authenticated device, for example, by using contactless communication or intra-body communication, and the user identifying and authenticating unit 602 can perform the user identification and authentication processing on the basis of an authentication pattern involving information read from the authenticated device.

FIG. 8 individually illustrates correspondences between identification patterns that the image display apparatus 1 with the typical configuration can use for the user identification and authentication processing and sensors and so on for obtaining the identification patterns. However, not only is one of the identification patterns used to perform the user identification and authentication processing, but also two or more identification patterns may be combined to realize more-flexible and higher-accuracy user identification and authentication processing, thereby making it possible to enhance security.

For example, an identification pattern involving a combination of a gaze-point movement and an eye-blinking action can also be used for the user identification and authentication processing. For example, the user creates an identification pattern by combining the movement of the gaze point from point A to point B in his or her field of view and an eye-blinking action at a halfway point C between points A and B. This identification pattern is distinguished from a mere gaze-point movement from point A to point B. Thus, even if a simple gaze-point movement pattern is found out by a third party who is behind or around the user, insertion of an eye-blinking action into the movement pattern can make impersonation difficult. Since the same sensor device can be used to detect the gaze point and the eye-blinking action, as can be seen from FIG. 8, a combination of these two types can also simplify the user identification and authentication processing.

A manufacturer or vendor of the image display apparatus 1 may pre-set which type of identification pattern the image display apparatus 1 is to use for the user identification and authentication processing, or the image display apparatus 1 may be configured so that a user can arbitrarily specify a type of identification pattern during initial setup after purchase.

One possible modification for inputting the identification pattern is a method in which a quiz or question to which only the user can know the answer is presented to the user, and the user answers by inputting any of the identification patterns illustrated in FIG. 8. Even when a quiz is displayed on the display panel 509, high security can be maintained since the details of the quiz are not visible from outside.

### C. Display of Guidance Information

As described above, when a user inputs an identification pattern at the start of using the image display apparatus 1 and when the user pre-registers his or her authentication pattern for the user identification and authentication, the guidance information that provides guidance for the user to input the identification pattern is displayed on the display panel 509. Thus, in accordance with the guidance-information displayed on the display panel 509, the user can perform a pattern input operation without error.

User authentication involving input of a personal identification number using a numeric keypad has been widely used. However, when the user performs an input operation of a personal identification number on equipment whose numeric keypad is exposed to outside, such as an automated teller machine (ATM) at a bank or store, he or she generally has to hide the numeric keypad with his or her body, or it is preferable to install a member that covers the numeric keypad so that no third party behind or around the user can peek at the personal identification number. In any case, the user has to perform an input operation of a personal identification number with an unnatural posture, which is inconvenient work and may cause erroneous input.

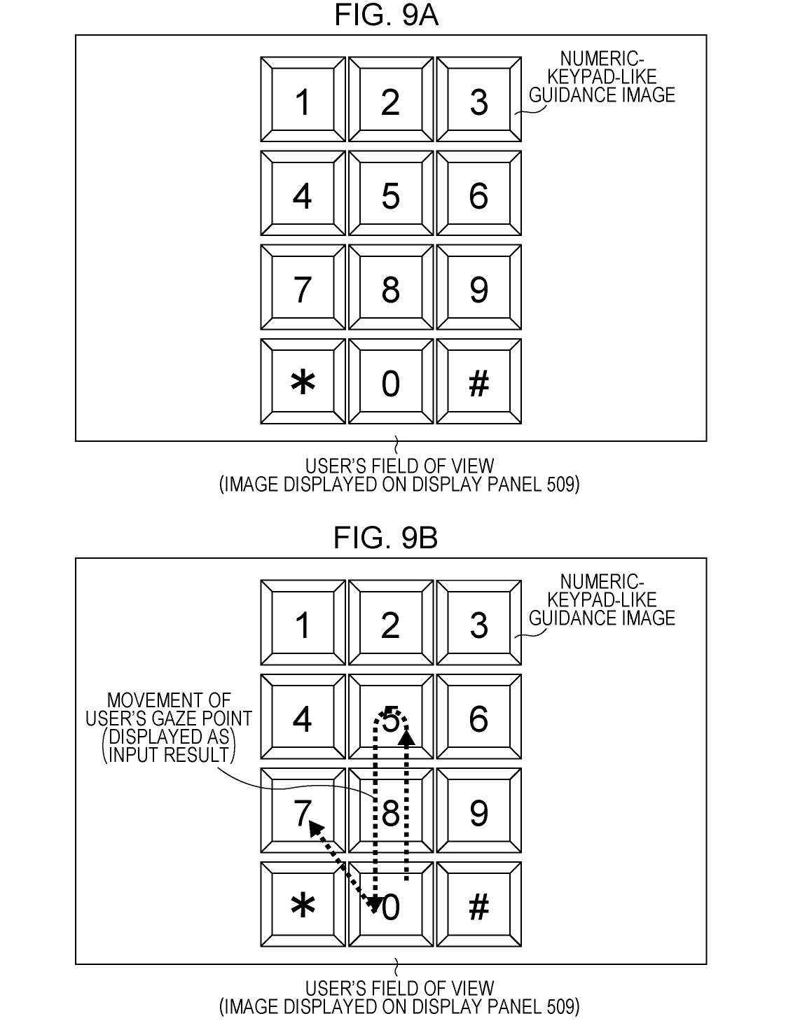

In contrast, according to the present embodiment, the display control unit 607 displays, on the display panel 509, for example, guidance information that emulates a numeric keypad, as illustrated in FIG. 9A. The user can then perform the input operation by sequentially gazing at corresponding numbers in the guidance information in accordance with a personal identification number he or she pre-registered. FIG. 9B illustrates a state in which a user inputs, via the guidance-information display screen illustrated in FIG. 9A, a personal identification number by using his or her line of sight. In the illustrated example, the user gazes at the numbers in the order 0-45-40-47 to input a personal identification number “0507”. By using the inside camera, the myoelectric sensor, or the electrooculogram sensor, the operation input unit 601 can identify the personal identification number “0507” by detecting in what order the user's gaze point passes over the numeric keypad.

In the present embodiment, since the numeric keypad displayed on the display panel 509 and the user's line of sight are hidden from the outside, it is very unlikely that a third party behind or around the user can peek at details of the personal identification number.

In FIG. 9B, the user's gaze-point movement detected using the inside camera, the myoelectric sensor, the electrooculogram sensor, or the like is depicted by dotted-line arrows. The display control unit 607 may be adapted to display the detected user's gaze-point movement on the guidance information in a superimposed manner, as illustrated in FIG. 9B. With such an arrangement, by seeing the thus-far input result on the screen on the display panel 509, the user can check whether or not the identification pattern has been properly input as he or she intended to.

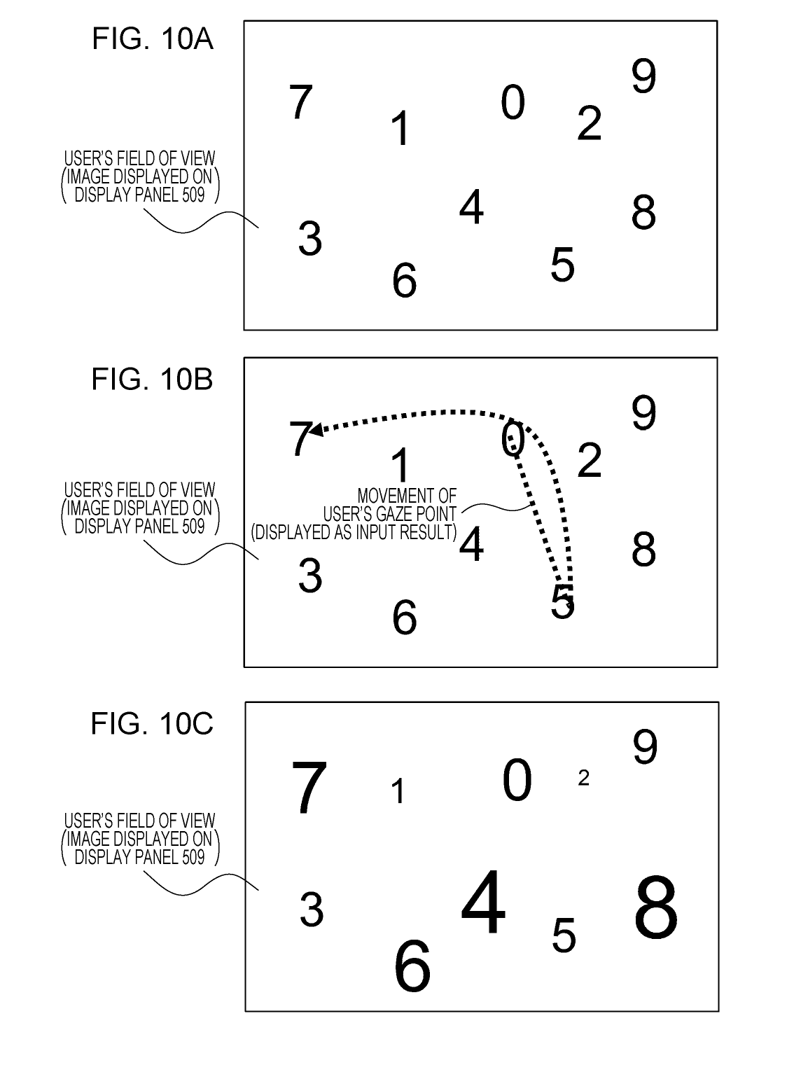

Rather than regularly arranging the numbers 0 to 9 in an ascending or descending order in a matrix as illustrated in FIG. 9A, the numbers may also be arranged irregularly in terms of a number sequence or locations based on a magnitude relationship of the numbers, as illustrated in FIG. 10A. FIG. 10B also illustrates a state in which the user inputs a personal identification number via the guidance-information display screen illustrated in FIG. 10A by using his or her line of sight. In the illustrated example, the user gazes at the numbers in the order 0-45-40-47 to input a personal identification number “0507”. Since the user's line of sight is hidden from the outside and the locations of the individual numbers are irregular, this makes it even more difficult for a third party behind or around the user to peek at the personal identification number.

In FIG. 10B, the user's gaze-point movement detected using the inside camera, the myoelectric sensor, the electrooculogram sensor, or the like is indicated by a dotted-line arrow. The display control unit 607 may also display the movement of the user's gaze point on the guidance information in a superposed manner, as illustrated in FIG. 10B. With such an arrangement, by seeing the input results on the screen on the display panel 509, the user can check whether or not the identification pattern has been properly input as he or she intended to.

As a modification of the guidance information illustrated in FIG. 10A, not only the number sequence or locations but also the font size may be made irregular, as illustrated in FIG. 10C.

For ATMs or entry control systems, there is a technology in which the locations of numeric keys are moved or changed in order to minimize the possibility that a personal identification number is stolen from behind a user or is found out from the movement and posture of the user (see, for example, Japanese Unexamined Patent Application Publication No. 6-318186). In this case, updating the pattern of the locations of the numeric keys every predetermined number of times makes it possible to reduce the risk of a personal identification number being found out as an input operation is repeated. However, after the pattern of the locations is updated, the user has to find new locations of the numeric keys he or she desires to input, which is cumbersome. In contrast, in the case of the head-mounted image display apparatus 1, the pattern of the locations of numbers as illustrated in FIG. 10A is hidden from the outside, and the input operation using the user's line of sight is also hidden from the outside. It is therefore difficult for a third party to find out a personal identification number, and the pattern of the locations of numbers may not be updated. Furthermore, the user can also perform successful authentication processing by using a line-of-sight movement he or she is used to, i.e., by repeating the same gaze-point movement pattern every time.

Rather than the user inputting a personal identification number by sequentially gazing at corresponding numbers in the manner described above, a trace that the user arbitrarily draws by moving his or her line of sight in his or her field of view may be used to perform the user identification and authentication processing. However, it is generally difficult for any user to draw the same trace in a blank space by the movement of his or her line of sight, each time he or she performs the user identification and authentication processing. Accordingly, guidance information in which multiple image objects that serve as targets at which the line of sight is set are scattered may also be displayed.

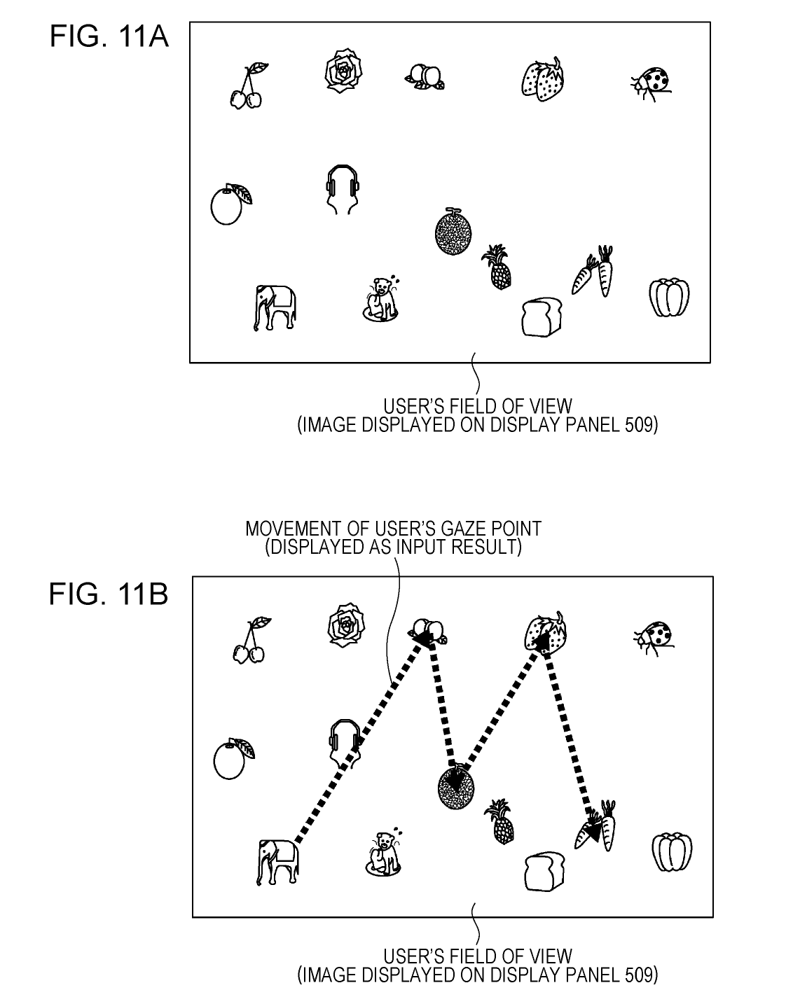

FIG. 11A illustrates an example of guidance information in which multiple image objects including food such as fruits, vegetables, and bread, animals, insects, electronic equipment, and so on are scattered. FIG. 11B illustrates a state in which the user draws a desired trace by moving his or her line of sight via the guidance-information display screen illustrated in FIG. 11A. In the illustrated example, the user draws a generally M-shaped trace by moving his or her line of sight in the order elephant→peach→melon→strawberry→carrot. On the basis of this trace pattern, the user identifying and authenticating unit 602 can perform the user identification and authentication processing.

With the guidance-information display screen illustrated in FIG. 11A, the user can draw a letter “M” having substantially the same size every time, by moving his or her line of sight in the order elephant, peach, melon, strawberry, and carrot, while targeting each image object. On the other hand, it will be difficult for the user to draw a desired shape, whether it is letter “M” or any other letter, within a blank field of view where no image objects that serve as targets for the line of sight exist, by moving his or her gaze point. The user may also use a trace pattern that traces image objects selected with a determination criterion only he or she can know, such as his or her favorite things, figures or things that appear in a certain story, or things that are easy to remember through his or her own association. By doing so, it is more difficult to forget the trace pattern compared with a case in which an inorganic password is used (or it is easier to remember it even if it is forgotten). The guidance images, i.e., the guidance information, depicted in FIGS. 11A and 11B are hidden from the outside and thus are difficult for a third party behind or around the user to find out, and the trace pattern the user draws by his or her line of sight is also difficult to find out.

In FIG. 11B, the user's gaze-point movement detected using the inside camera, the myoelectric sensor, the electrooculogram sensor, or the like is depicted by dotted-line arrows. The display control unit 607 may also display the movement of the user's gaze point on the guidance information in a superposed manner, as that illustrated in FIG. 11B. With such an arrangement, by seeing the thus-far input result on the screen on the display panel 509, the user can check whether or not the identification pattern has been properly input as he or she intended to.

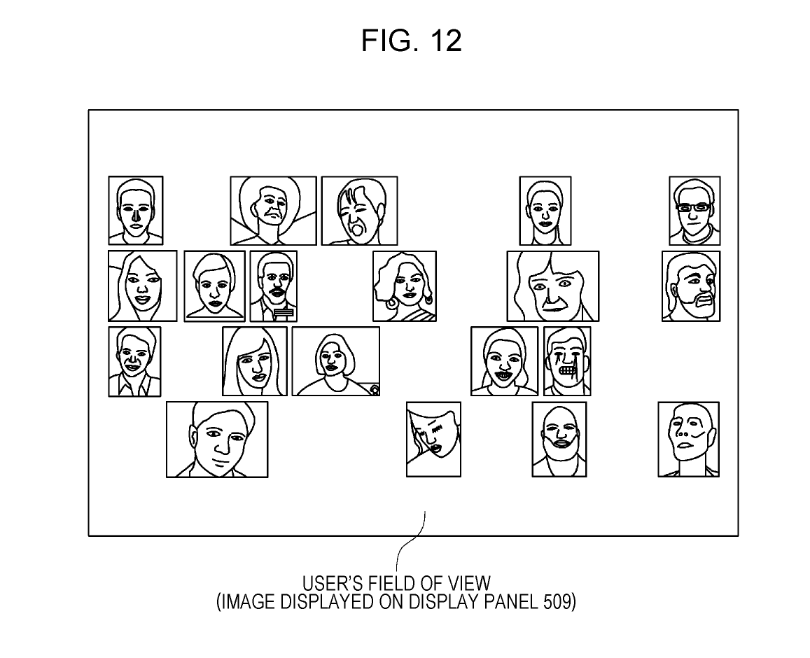

In the guidance information illustrated in FIG. 11A, as described above, image objects including food, such as fruits, vegetables, and bread, animals, insects, electronic equipment, and so on are arranged in the user's field of view as targets for the line of sight. However, various other image objects can also be used. For example, guidance information (not illustrated) in which alphabets, hiragana, katakana, kanji, and so on are randomly arranged may be used. In such a case, the user can input a gaze-point trace pattern, for example, by tracing, with his or her line of sight, a character string representing his or her favorite phrase or an easy-to-remember word. Alternatively, as illustrated in FIG. 12, guidance information in which a large number of face images are randomly (or regularly) arranged may be used. In such a case, the user can input a gaze-point trace pattern, for example, by tracing his or her favorite faces with his or her line of sight. Alternatively, if face images of the user's acquaintances, relatives, or family members are randomly inserted into the guidance information, it is easier to remember the gaze-point trace pattern.

In multifunction information terminals, such as smartphones, for example, a pattern lock technology is available (see, for example, U.S. Pat. No. 8,136,053). In this technology, for example, a user moves his or her finger between dots, displayed on a touch panel in a matrix, in a preferred order, and how the finger was moved is stored. Subsequently, when the same finger movement is reproduced, the user is permitted to use the device. However, since the dots displayed on the touch panel and the user's movement action on the touch panel are both exposed to outside, the possibility of a third parity behind or around the user peeking and finding out the same movement still remains. In contrast, according to the present embodiment, since the guidance information (the arranged image objects that serve as targets for the user's line of sight) displayed on the display panel 509 and the position of the user's line of sight are both hidden from the outside, there is no gap through which a third party can peek. Thus, the user identification and authentication processing can be performed in a secure manner.

Up to this point, a description has been given of an example of the guidance information when the user's line of sight involving the movement of a gaze position or gaze point or the like is used as the identification pattern for the user identification and authentication processing. When another type of identification pattern that can be obtained by the image display apparatus 1 is used, displaying the guidance information also makes it easier for the user to input the identification pattern without error.

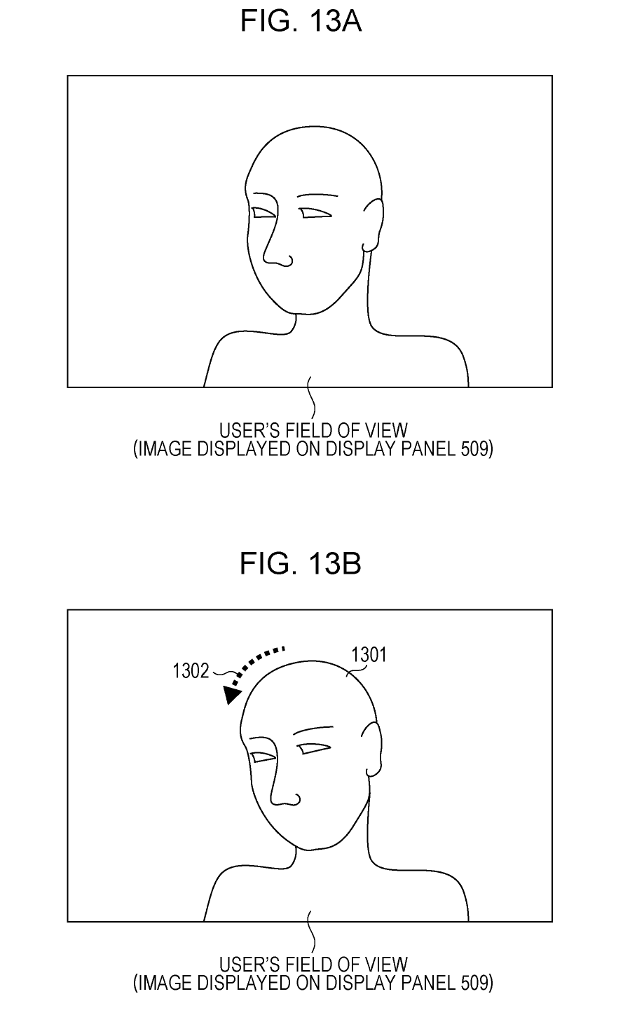

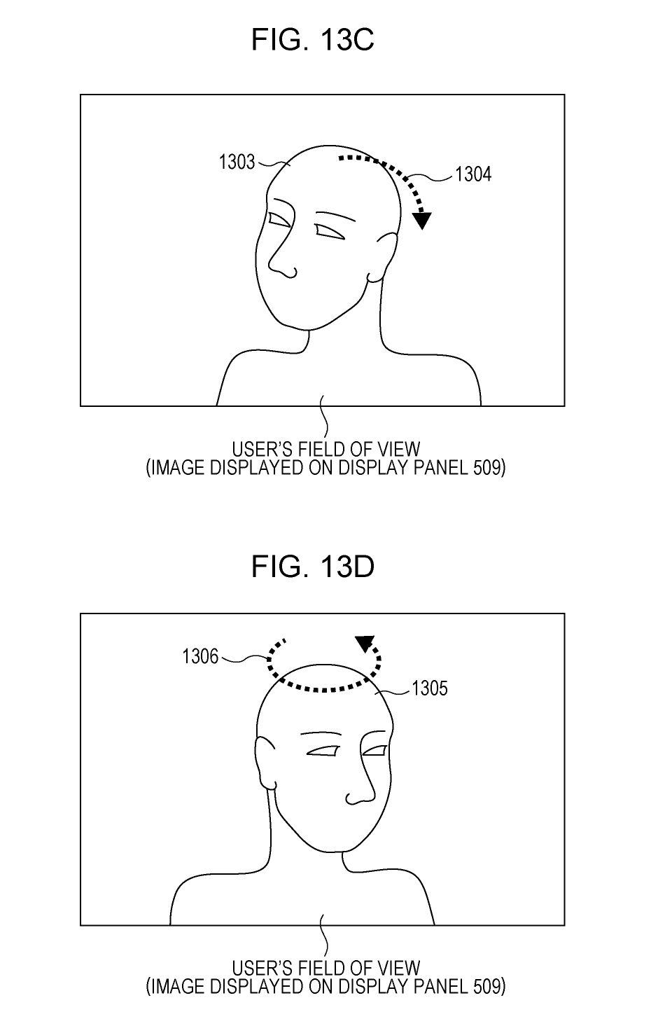

For example, when an identification pattern for the user's head, such as shaking his or her head to the left or right is input, a model of a human head is displayed on the display panel 509 as the guidance information, as illustrated in FIG. 13A. When it is detected that the user has tilted his or her head forward (i.e., has nodded) through use of the acceleration sensor, the gyro-sensor, the outside camera, or the like, a gesture of tilting the head forward, as indicated by reference numeral 1301, and the direction of the tilted head, as indicated by reference numeral 1302, are indicated by a dotted-line arrow, as illustrated in FIG. 13B. When it is detected that the user has tilted his or her head to the right, a gesture of tilting the head to the right, as indicated by reference numeral 1303, and the direction of the tilted head, as indicated by reference numeral 1304, are indicated by a dotted-line arrow, as illustrated in FIG. 13C. When it is detected that the user has turned his or her head counterclockwise about the yaw axis thereof, a gesture of turning the head about the yaw axis, as indicated by reference numeral 1305, and the direction of the head turned about the yaw axis, as indicated by reference numeral 1306, are indicated by a dotted-line arrow, as illustrated in FIG. 13D. By seeing the thus-far input result on the screen on the display panel 509, the user can check whether or not the identification pattern has been input as he or she intended to.

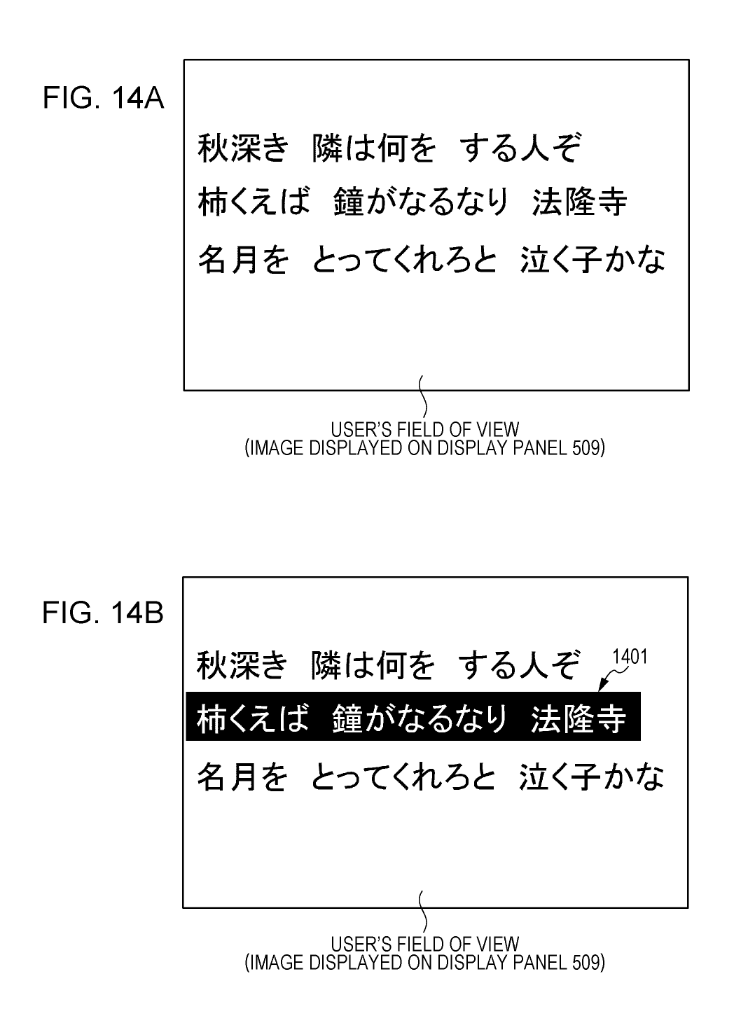

When voice output by the user or a speech bone-conduction signal is input as an identification pattern for the user identification and authentication, speech text pre-registered by the user and multiple texts including dummy text are displayed on the display panel 509 as guidance information, as illustrated in FIG. 14A. When voice input via the microphones is recognized, the text for which speech was recognized is highlighted (or is displayed in an enhanced manner) as indicated by reference numeral 1401 in FIG. 14B, to indicate that an identification pattern involving the voice of the user has been recognized. By seeing the thus-far input result on the screen on the display panel 509, the user can check whether or not voice has been recognized as he or she intended to.

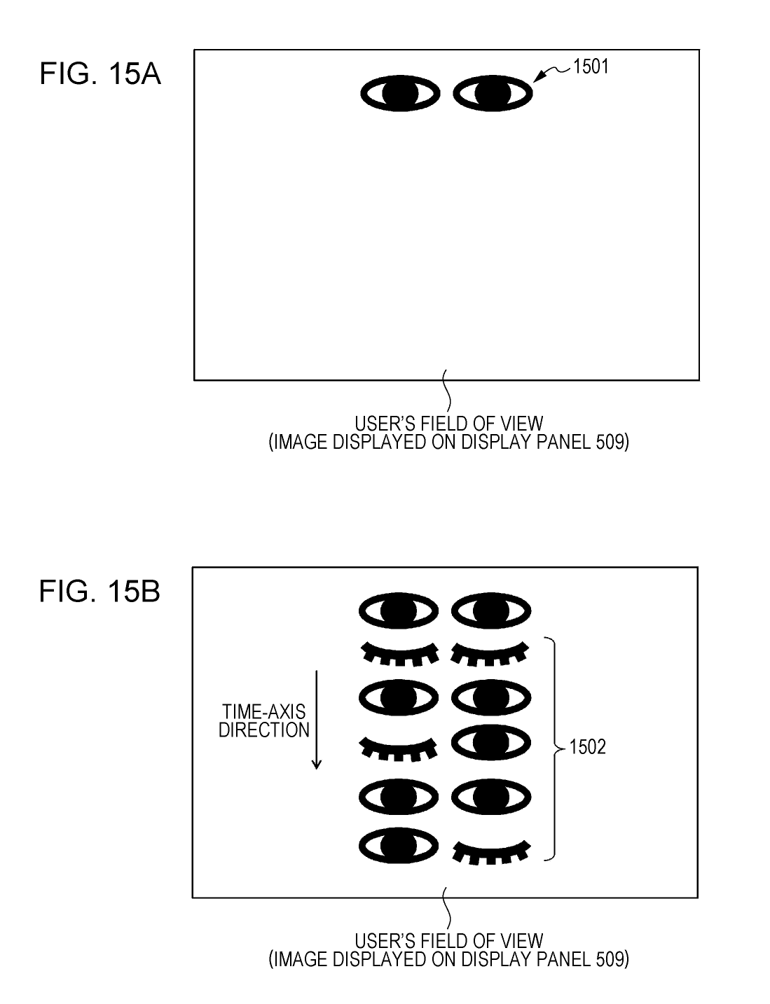

When the user's action of blinking one or both of the left and right eyes is input as an identification pattern for the user identification and authentication, an image 1501 showing both eyes open, which is an initial state, is displayed on the display panel 509 as guidance information, as illustrated in FIG. 15A. Then, each time the user's action of blinking one or both of the left and right eyes is detected using the inside camera, the myoelectric sensor, the electrooculogram sensor, or the like, icons 1502 representing the detected blinking action are time-sequentially displayed as illustrated in FIG. 15B. In an example illustrated in FIG. 15B, the direction from the top to the bottom of the plane of the figure corresponds to a time-axis direction, and FIG. 15B indicates that eye-blinking actions were detected in the order: blinking of the left eye, blinking of the right eye, and blinking of both eyes. With such an arrangement, by seeing the thus-far input result on the screen on the display panel 509, the user can check whether or not the identification pattern for blinking has been properly input as he or she intended to.

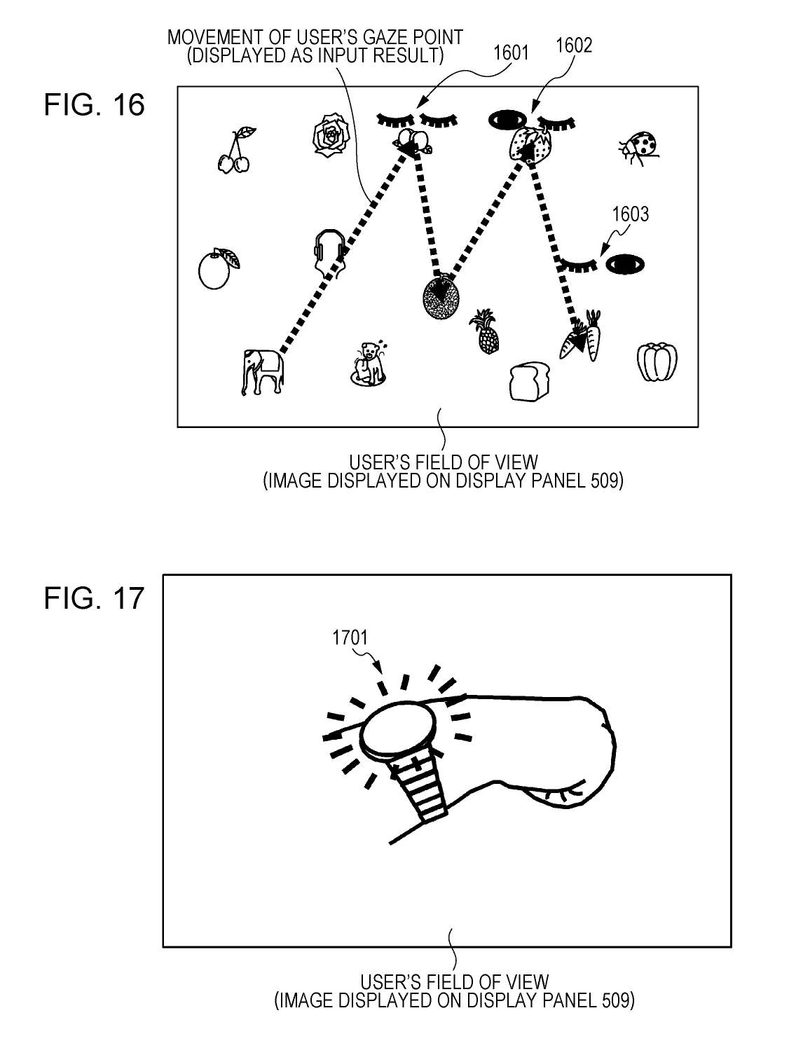

An identification pattern involving a combination of a gaze-point movement and a blinking action may also be used to perform the user identification and authentication processing, as described above. In such a case, icons representing blinking actions may be displayed at, along a gaze-point trace pattern, the positions where blinking actions of both eyes, the left eye, and the right eye were detected, as indicated by reference numerals 1601, 1602, and 1603 in FIG. 16, so as to indicate that the eye-blinking actions were detected.

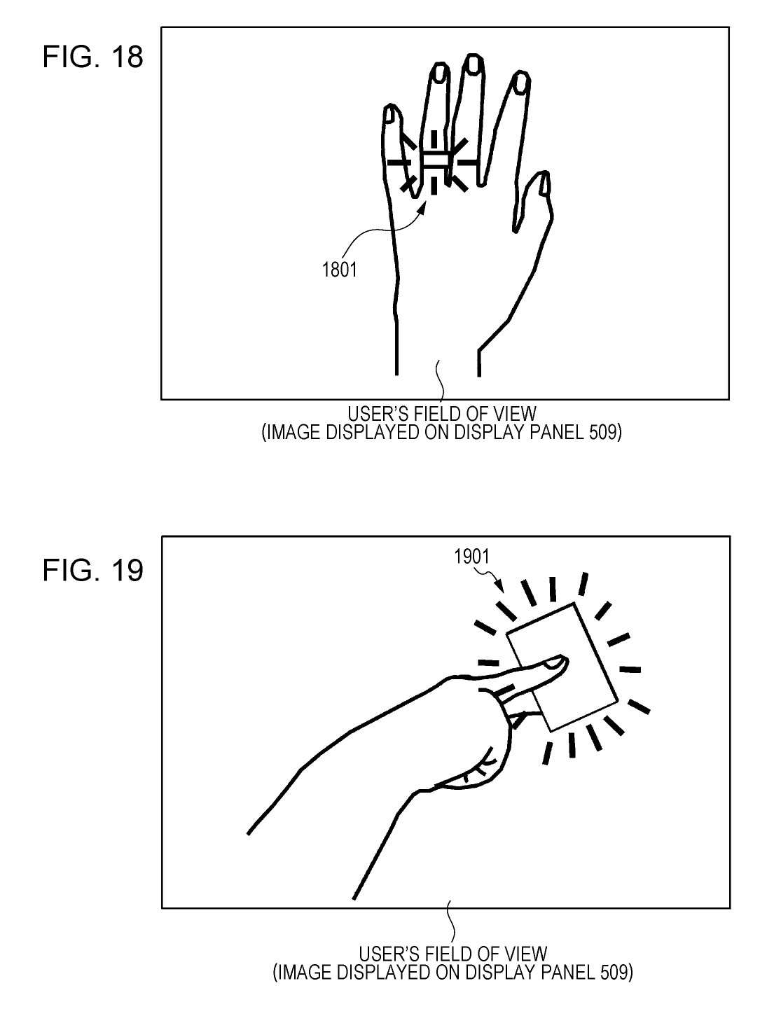

In a case in which the image display apparatus 1 performs the user identification and authentication processing using intra-body communication with an authenticated device in the form of a wristwatch, a ring, or a card the user is wearing or carrying with him or her, when the user has not worn it or has not carried it with him or her yet, guidance information for prompting the user to wear the authenticated device or carry it with him or her is displayed on the display panel 509, as indicated by reference numeral 1701 in FIG. 17, reference numeral 1801 in FIG. 18, or reference numeral 1901 in FIG. 19.

Thus, according to the present embodiment, an identification pattern for a user wearing the image display apparatus 1 on his or her head or facial area to perform the user identification and authentication processing can be input from a device generally included in the image display apparatus 1, so that the user identification and authentication processing can be performed in a simplified manner and at low cost.

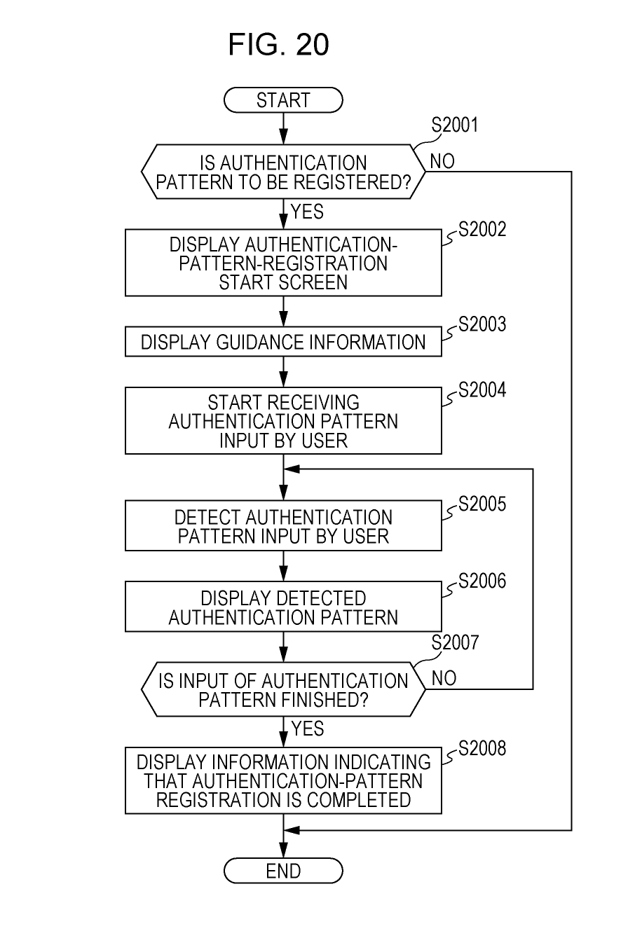

FIG. 20 is a flowchart illustrating a processing procedure for pre-registering, in the image display apparatus 1, an authentication pattern used for the user identification and authentication processing. The illustrated procedure is initiated automatically or based on a setup operation by the user, for example, when the image display apparatus 1 is powered on for the first time (or each time it is powered on when no identification pattern has been registered).

First, the user identifying and authenticating unit 602 instructs the display control unit 607 to display, on the display panel 509, a confirmation screen for checking with the user as to whether or not to start registering an authentication pattern used for the user identification and authentication processing. The process then proceeds to step S2001. When the user does not desire to register an authentication pattern (NO in step S2001), all of the subsequent processing steps are skipped and this processing routine is ended.

On the other hand, when the user desires to register an authentication pattern (YES in step S2001), an authentication-pattern-registration start screen (not illustrated) is displayed in step S2002. The arrangement may also be such that the user can select, on the authentication-pattern-registration start screen, the type of identification pattern to be used for the user identification and authentication processing.

In step S2003, the user identifying and authenticating unit 602 instructs the display control unit 607 to display, on the display panel 509, guidance information corresponding to the type of identification pattern. In step S2004, the user identifying and authenticating unit 602 instructs the operation input unit 601 to receive an input from a sensor corresponding to the type of identification pattern, to thereby start receiving an authentication pattern input by the user.

The user inputs, to the image display apparatus 1, an authentication pattern he or she desires to register. When the sensor that has started the input reception detects an authentication pattern input by the user (in step S2005), the operation input unit 601 outputs a result of the detection to the user identifying and authenticating unit 602.

In step S2006, the user identifying and authenticating unit 602 displays, on the screen on the display panel 509 where the guidance information is displayed, the authentication pattern input from the operation input unit 601. Through the display screen, the user can check whether or not the authentication pattern he or she desires to register has been input as intended.

When the user gives a notification indicating that the input of the authentication pattern is finished by using the input operation unit 502 or the like or when a predetermined amount of time passes after an input from the user has stopped and then it is recognized that the input operation is finished (YES in step S2007), the user identifying and authenticating unit 602 instructs the authentication-pattern registering unit 603 to register the authentication pattern input from the operation input unit 601. In step S2008, the user identifying and authenticating unit 602 instructs the display control unit 607 to display, on the display panel 509, information indicating that the authentication-pattern registration processing is completed. Thereafter, this processing routine is ended.

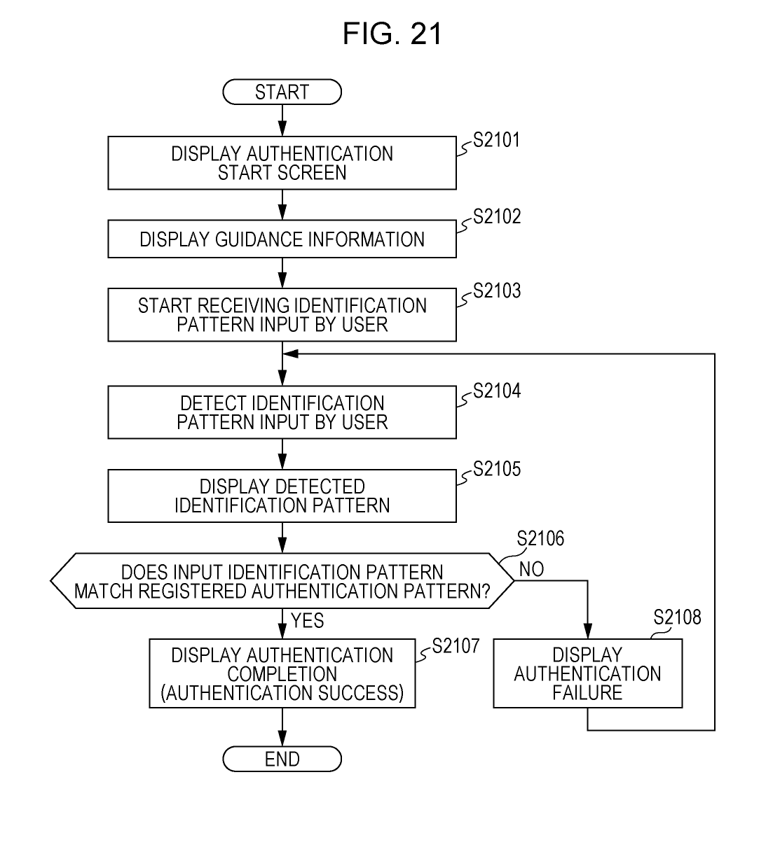

FIG. 21 is a flowchart illustrating a procedure of the user identification and authentication processing performed by the image display apparatus 1. For example, once the authentication pattern is registered in the image display apparatus 1, the illustrated procedure is automatically initiated each time the image display apparatus 1 is powered on or each time it is detected that the user wearing the image display apparatus 1 on his or her head or facial area.

First, in step S2101, the user identifying and authenticating unit 602 instructs the display control unit 607 to display, on the display panel 509, a screen indicating start of authentication.

The authentication start screen is not illustrated. For example, when the user has registered multiple types of identification pattern, the image display apparatus 1 may be configured so as to allow the user to select, on the authentication start screen, the type of identification pattern to be used for the user identification and authentication processing.

In step S2102, the user identifying and authenticating unit 602 instructs the display control unit 607 to display, on the display panel 509, guidance information corresponding to the type of identification pattern.

In step S2103, the user identifying and authenticating unit 602 instructs the operation input unit 601 to receive an input from a sensor corresponding to the type of identification pattern, to thereby start receiving an identification pattern input by the user.

While utilizing the displayed guidance information, the user inputs an identification pattern on the basis of his or her memory. Upon detecting an identification pattern input by the user from the sensor that has started the input reception (in step S2104), the operation input unit 601 outputs a result of the detection to the user identifying and authenticating unit 602.

In step S2105, the user identifying and authenticating unit 602 displays, on the screen on the display panel 509 where the guidance information is displayed, the identification pattern input from the operation input unit 601. Through the display screen, the user can check whether or not the identification pattern he or she remembers has been input as intended.

In step S2106, the user identifying and authenticating unit 602 compares the input identification pattern with the authentication pattern pre-registered through the procedure illustrated in FIG. 20 and checks the authenticity of the user on the basis of whether or not the input identification pattern matches the authentication pattern.

A threshold for the determination made in step S2106 may be rough to some extent. For example, the threshold may be adjusted to a degree at which a determination in a family can be made or a determination as to whether the user is an adult or a child can be made. When the threshold is set to a rough value, the security declines, but there is an advantage in that, for example, the time taken until completion of the user identification and authentication processing can be reduced.

When the degree of matching between the input identification pattern and the pre-registered authentication pattern exceeds the predetermined threshold (YES in step S2106), the user identifying and authenticating unit 602 regards the user identification or authentication processing as being successful and displays an authentication completion screen (not illustrated) in step S2107. Thereafter, this processing routine is ended.

When the user identification and authentication processing succeeds, the user identifying and authenticating unit 602 reports a result to that effect to the application-execution permitting unit 605. Upon receiving, from the user identifying and authenticating unit 602, the result indicating that the user identification and authentication processing has succeeded, the application-execution permitting unit 605 permits execution of an application with respect to an application execute instruction subsequently given by the user.

The result indicating that the authentication is successful may be kept effective while the user continuously wears the image display apparatus 1 on his or her head or facial area. Alternatively, even while the user continuously wears the image display apparatus 1, a request for inputting an identification pattern is re-issued so as to perform the user identification and authentication processing, each time a certain period of time passes or a break in content for viewing/listening is reached.

When the degree of matching between the input identification pattern and the pre-registered authentication pattern is lower than the predetermined threshold (NO in step S2106), the user identifying and authenticating unit 602 regards the user identification or authentication processing as being unsuccessful and displays an authentication failure screen (not illustrated) in step S2108. Subsequently, the process returns to step S2104 in which an identification pattern input by the user is received again, and the user identification and authentication processing is repeatedly executed. However, when the number of failures in the authentication processing reaches a predetermined number of times or when the authentication processing does not complete within a predetermined period of time after the start of the procedure illustrated in FIG. 21, it is regarded that the authentication of the user has failed, and this processing routine is ended.

When the user identification and authentication processing fails, the user identifying and authenticating unit 602 reports a result to that effect to the application-execution permitting unit 605. Upon receiving, from the user identifying and authenticating unit 602, the result indicating that the user identification and authentication processing has failed, the application-execution permitting unit 605 disallows execution of an application with respect to an application execute instruction subsequently given by the user.

Thus, according to the present embodiment, on the basis of the identification pattern directly input by the user, the image display apparatus 1 performs the user identification and authentication processing in a simplified manner and at low cost, and on the basis of a result of the user identification and authentication processing, the image display apparatus 1 can permit or disallow execution of an application.

The technology disclosed herein may also have a configuration as follows.

(1) An image display apparatus used while it is mounted on a user's head or facial area, the image display apparatus including:

a display unit configured to display an inside image viewable from the user;

an input unit configured to input an identification pattern from the user;

a checking unit configured to check the identification pattern; and

a control unit configured to control the image display apparatus on the basis of a result of the checking by the checking unit.

(2) The image display apparatus according to (1), wherein the checking unit checks authenticity of the user, and

on the basis of whether or not the user is authentic, the control unit determines whether or not predetermined processing is to be executed on the image display apparatus.

(3) The image display apparatus according to (1), further including an authentication-pattern registering unit configured to pre-register an authentication pattern that an authentic user inputs via the input unit,

wherein the checking unit checks the authenticity of the user on the basis of a degree of matching between an identification pattern that the user inputs via the input unit and an authentication pattern pre-registered in the authentication-pattern registering unit.

(4) The image display apparatus according to (1), further including a line-of-sight detecting unit configured to detect the user's line of sight,

wherein the input unit inputs an identification pattern based on the user's gaze-position or gaze-point movement obtained from the line-of-sight detecting unit.

(5) The image display apparatus according to (4), wherein the line-of-sight detecting unit includes at least one of an inside camera capable of photographing an eye of the user, a myoelectric sensor, and an electrooculogram sensor.

(6) The image display apparatus according to (1), further including a motion detecting unit configured to detect movement of the head or body of the user wearing the image display apparatus,

wherein the input unit inputs an identification pattern based on the user's head or body movement obtained from the motion detecting unit.

(7) The image display apparatus according to (6), wherein the motion detecting unit includes at least one of an acceleration sensor, a gyro-sensor, and a camera.

(8) The image display apparatus according to (1), further including

a voice detecting unit configured to detect voice uttered by the user,

wherein the input unit inputs an identification pattern based on the voice obtained from the voice detecting unit.

(9) The image display apparatus according to (1), further including a bone-conduction signal detecting unit configured to detect a speech bone-conduction signal resulting from utterance of the user,

wherein the input unit inputs an identification pattern based on the speech bone-conduction signal obtained from the bone-conduction signal detecting unit.

(10) The image display apparatus according to (1), further including a feature detecting unit configured to detect a shape feature of the user's face or facial part,

wherein the input unit inputs an identification pattern based on the shape feature of the user's face or facial part.

(11) The image display apparatus according to (10), wherein the feature detecting unit detects at least one of shape features of an eye shape, an inter-eye distance, a nose shape, a mouth shape, a mouth opening/closing operation, an eyelash, an eyebrow, and an earlobe of the user.

(12) The image display apparatus according to (1), further including an eye-blinking detecting unit configured to detect an eye-blinking action of the user,

wherein the input unit inputs an identification pattern based on the user's eye blinking obtained from the eye-blinking detecting unit.

(13) The image display apparatus according to (12), wherein the eye-blinking detecting unit includes at least one of an inside camera capable of photographing the user's eye, a myoelectric sensor, and an electrooculogram sensor.

(14) The image display apparatus according to (1), further including a feature detecting unit configured to detect a shape feature of the user's hand, finger, or fingerprint,

wherein the input unit inputs an identification pattern based on the shape feature of the user's hand, finger, or fingerprint.

(15) The image display apparatus according to (1), further including an intra-body communication unit configured to perform intra-body communication with an authenticated device worn by the user or carried by the user with him or her and to read information from the authenticated device,

wherein the input unit inputs an identification pattern based on the information read from the authenticated device by the intra-body communication unit.

(16) The image display apparatus according to (1), further including a guidance-information display unit configured to display, on the display unit, guidance information that provides guidance for an operation by which the user inputs an identification pattern via the input unit.

(17) The image display apparatus according to (3), further including a guidance-information display unit configured to display, on the display unit, guidance information that provides guidance for an operation by which an authentication pattern is input, when the user pre-registers an authentication pattern in the authentication-pattern registering unit.

(18) The image display apparatus according to (1), further including an input-result display unit configured to display, on the display unit, a result of the user inputting an identification pattern via the input unit.

(19) An image display method for an image display apparatus used while it is mounted on a user's head or facial area, the image display method including:

inputting an identification pattern from the user;

checking the identification pattern; and

controlling the image display apparatus on the basis of a result of the checking.

(20) A computer program written in a computer-readable format so as to control, on a computer, operation of an image display apparatus used while mounted on a user's head or facial area, the computer program causing the computer to function as:

a display unit that displays an inside image viewable from the user;

an input unit that inputs an identification pattern from the user;

a checking unit that checks the identification pattern; and

a control unit that controls the image display apparatus on the basis of a result of the checking by the checking unit.

The technology disclosed herein has been described above by way of example, and the contents described herein are not be construed as limiting. The scope of the appended claims is to be construed in order to understand the substance of the technology disclosed herein.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus used while it is mounted on a user's head or facial area, the image display apparatus comprising:
a display unit configured to display an inside image viewable from the user;
an input unit configured to input an identification pattern from the user;
a checking unit configured to check the identification pattern; and
a control unit configured to control the image display apparatus on the basis of a result of the checking by the checking unit.

2. The image display apparatus according to claim 1, wherein
the checking unit checks authenticity of the user, and
on the basis of whether or not the user is authentic, the control unit determines whether or not predetermined processing is to be executed on the image display apparatus.

3. The image display apparatus according to claim 1, further comprising
an authentication-pattern registering unit configured to pre-register an authentication pattern that an authentic user inputs via the input unit,
wherein the checking unit checks the authenticity of the user on the basis of a degree of matching between an identification pattern that the user inputs via the input unit and an authentication pattern pre-registered in the authentication-pattern registering unit.

4. The image display apparatus according to claim 1, further comprising
a line-of-sight detecting unit configured to detect the user's line of sight,
wherein the input unit inputs an identification pattern based on the user's gaze-position or gaze-point movement obtained from the line-of-sight detecting unit.

5. The image display apparatus according to claim 4, wherein
the line-of-sight detecting unit comprises at least one of an inside camera capable of photographing an eye of the user, a myoelectric sensor, and an electrooculogram sensor.

6. The image display apparatus according to claim 1, further comprising
a motion detecting unit configured to detect movement of the head or body of the user wearing the image display apparatus,
wherein the input unit inputs an identification pattern based on the user's head or body movement obtained from the motion detecting unit.

7. The image display apparatus according to claim 6, wherein
the motion detecting unit comprises at least one of an acceleration sensor, a gyro-sensor, and a camera.

8. The image display apparatus according to claim 1, further comprising
a voice detecting unit configured to detect voice uttered by the user,
wherein the input unit inputs an identification pattern based on the voice obtained from the voice detecting unit.

9. The image display apparatus according to claim 1, further comprising
a bone-conduction signal detecting unit configured to detect a speech bone-conduction signal resulting from utterance of the user,
wherein the input unit inputs an identification pattern based on the speech bone-conduction signal obtained from the bone-conduction signal detecting unit.

10. The image display apparatus according to claim 1, further comprising
a feature detecting unit configured to detect a shape feature of the user's face or facial part,
wherein the input unit inputs an identification pattern based on the shape feature of the user's face or facial part.

11. The image display apparatus according to claim 10, wherein
the feature detecting unit detects at least one of shape features of an eye shape, an inter-eye distance, a nose shape, a mouth shape, a mouth opening/closing operation, an eyelash, an eyebrow, and an earlobe of the user.

12. The image display apparatus according to claim 1, further comprising
an eye-blinking detecting unit configured to detect an eye-blinking action of the user,
wherein the input unit inputs an identification pattern based on the user's eye blinking obtained from the eye-blinking detecting unit.

13. The image display apparatus according to claim 12, wherein
the eye-blinking detecting unit comprises at least one of an inside camera capable of photographing the user's eye, a myoelectric sensor, and an electrooculogram sensor.

14. The image display apparatus according to claim 1, further comprising
a feature detecting unit configured to detect a shape feature of the user's hand, finger, or fingerprint,
wherein the input unit inputs an identification pattern based on the shape feature of the user's hand, finger, or fingerprint.

15. The image display apparatus according to claim 1, further comprising
an intra-body communication unit configured to perform intra-body communication with an authenticated device worn by the user or carried by the user with him or her and to read information from the authenticated device,
wherein the input unit inputs an identification pattern based on the information read from the authenticated device by the intra-body communication unit.

16. The image display apparatus according to claim 1, further comprising
a guidance-information display unit configured to display, on the display unit, guidance information that provides guidance for an operation by which the user inputs an identification pattern via the input unit.

17. The image display apparatus according to claim 3, further comprising
a guidance-information display unit configured to display, on the display unit, guidance information that provides guidance for an operation by which an authentication pattern is input, when the user pre-registers an authentication pattern in the authentication-pattern registering unit.

18. The image display apparatus according to claim 1, further comprising
an input-result display unit configured to display, on the display unit, a result of the user inputting an identification pattern via the input unit.

19. An image display method for an image display apparatus used while it is mounted on a user's head or facial area, the image display method comprising:
inputting an identification pattern from the user;
checking the identification pattern; and
controlling the image display apparatus on the basis of a result of the checking.

20. A computer program written in a computer-readable format so as to control, on a computer, operation of an image display apparatus used while mounted on a user's head or facial area, the computer program causing the computer to function as:
a display unit that displays an inside image viewable from the user;
an input unit that inputs an identification pattern from the user;
a checking unit that checks the identification pattern; and
a control unit that controls the image display apparatus on the basis of a result of the checking by the checking unit.
